(19) United States
(12) Patent Application Publication
(10) Pub. No.: US 2013/0217365 A1
(43) Pub. Date: Aug. 22, 2013

(54) AUTOMATIC PROFILE UPDATE IN A MOBILE DEVICE WITH TRANSACTIONAL AND SOCIAL INTELLIGENCE CAPABILITIES

(71) Applicant: Manoj Ramnani, Vienna, VA (US)

(72) Inventor: Manoj Ramnani, Vienna, VA (US)

(21) Appl. No.: 13/401,490

(22) Filed: Feb. 21, 2012

(51) Int. Cl. H04W 4/16

(52) U.S. Cl. 455/414.1

(57) ABSTRACT

A method and system for crowdsourcing and managing contact and profile information of a user's contacts, and exchanging business and personal contact information through a mobile device, personal computer, or a web application. The system comprises a crowdsourcing intelligence module that provides the software, analysis, and algorithms for automatically populating and updating an individual's contact information in a user's address book based on contributed information and changes made to the individual's profile by a large community of users. The module also automatically populates and updates business profile, captures business's external social and business profiles, and analyzes demographic information which can then be transmitted to users. Users may also search for job opportunities, review and purchase products and services, review the location of contacts in proximity to the user, and manage sales and account activities including lead generation, lead qualification, and better understanding their customer base.

### CROSS REFERENCE TO RELATED APPLICATION

This application is a continuation in part of PCT Application US2009/004088 which claims the benefit of the filing date of U.S. Provisional Application Ser. No. 61/080,697, entitled “AUTOMATIC PROFILE UPDATE IN A MOBILE DEVICE”, the entirety of both are incorporated herein.

### BACKGROUND OF THE INVENTION

1. Field of the Invention

The invention, in general, relates to electronic business cards. More particularly, this invention relates to a method of exchanging electronic business cards through mobile phones between a user and contacts of the user. The contacts of the user may comprise personal and business contacts of the user. The contacts might also be commercial enterprises which enable the user to receive real time offerings and information and to conduct transactions through the system.

2. Description of the Related Art

Electronically cataloging traditional business cards may be time consuming and prone to error. Business card information logged into an electronic contact management system may become obsolete over a period of time. The user may run out of the traditional business cards for exchange with the user's business contacts. The user may need to track relationship context along with the business card information of the user's business contacts to make note of context information such as place, time, relationship with a particular business contact, etc. The user may also need to send updates to the business card information of the user to user's business contacts in real time. The updates to the user's business card information may comprise a change in job profile, address, phone number or email address of the user. The user may also need to stay updated on the latest business card information of the user's business contacts at all times.

The user may also lose electronic business cards received from user's business contacts due to loss, malfunction, or replacement of the user's mobile device. Therefore, for an instance of loss of the electronic business cards, the user may need a backup of the electronic business cards of the user's personal and business contacts to retrieve the electronic business cards back on the mobile device of the user. The user may also want to send updated contact information to new business contacts through the user's mobile device automatically without user intervention. Existing online service providers' provide communication means to exchange business card information through web sites and electronic mails (emails), and business card scans stored on computer. The communication means provided by the existing online service providers may not capture the context of the exchange, for example, time and date of exchange, user notes, location, etc., nor may it capture social media information (e.g. blogs, LinkedIn, Facebook, or Twitter information). However, means to exchange the business card information instantly using mobile phones may not be provided by the online service providers.

Therefore, there is need for a method and a system that enables the user to exchange electronic business cards instantly through the user's mobile phone, share business card information (including social media information and context) with the user's business contacts, and capture context of meetings with the business contacts. There is also a need for the method and the system for storing the electronic business cards of the user's business contacts on a central server as a backup means. There is also a need for the method and the system to automatically update modified business card information of the user's business contacts on the user's mobile device and vice versa.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method and system disclosed herein provides a mobile client on a requestor's first mobile device. The requestor provides requestor profile to an information exchange server through the mobile client. The requestor requests a connection with the recipient using the mobile client. The mobile client is provided on a recipient's second mobile device. The recipient provides recipient profile to the information exchange server through the mobile client. On acceptance of the request for connection by the recipient, the information exchange server transfers the recipient profile to the mobile client on the requestor's first mobile device and vice versa. The mobile client automatically updates the transferred recipient profile on the requestor's first mobile device based on changes made by the recipient to the recipient profile and vice versa.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of managing mobile exchange of profile information between a requestor and a recipient.

FIG. 2 illustrates a system of managing mobile exchange of profile information between a requestor and a recipient.

FIG. 3A exemplarily illustrates mobile exchange of profile information between computing devices via a network.

FIG. 3B is an exemplary logical system architecture for the mobile exchange of profile information between computing devices via a network.

FIG. 4 exemplarily illustrates a flowchart of a process of a recipient installing a mobile client on a mobile device of the recipient based on request for connection by a requestor.

FIG. 5 exemplarily illustrates a flowchart of a process of a public user installing a mobile client on a smartphone.

FIG. 6 exemplarily illustrates a flowchart of a process of a public user installing a mobile client on a smartphone by accessing a host website from the public user's smartphone.

FIG. 7 exemplarily illustrates a flowchart of a process of providing a mobile client to a public user.

FIGS. 8A-8K exemplarily illustrate user actions performed by a user using a mobile client on a mobile device of the user.

FIG. 9 depicts an exemplary illustration of a mobile device.

FIG. 10A exemplarily illustrates the graphical user interface of the main page, including the map functionality, on a mobile device of the user.

FIG. 10B exemplarily illustrate user actions performed by a user using the mobile client's map functionality on a mobile device of the user.

FIG. 11A exemplarily illustrates the main page, including the search functionality, on a mobile device of the user.

FIG. 11B exemplarily illustrates the graphical user interface of the search results for service providers on a mobile device of the user.

FIG. 11C exemplarily illustrates a map displaying local service providers nearby on a mobile device of the user.

FIG. 12 exemplarily illustrates a system and method that allows for a large group or community to contribute information about their contacts that is then shared among the community.

FIG. 13A exemplarily illustrates the auto-population of contact information into the mobile client.

FIG. 13B exemplarily illustrates the breakdown of a user's profile information, including personal information, business information, company information, and my entry history.

FIG. 14 illustrates a flow chart for the contact sharing and auto-populating fields of a contact's information when a user adds a new contact.

FIG. 15 illustrates a flow chart for updating the cloud based shared contact information when a contact's information is changed.

### DETAILED DESCRIPTION OF EXEMPLARY EMBODIMENTS

Particular embodiments of the present invention will now be described in greater detail with reference to the figures.

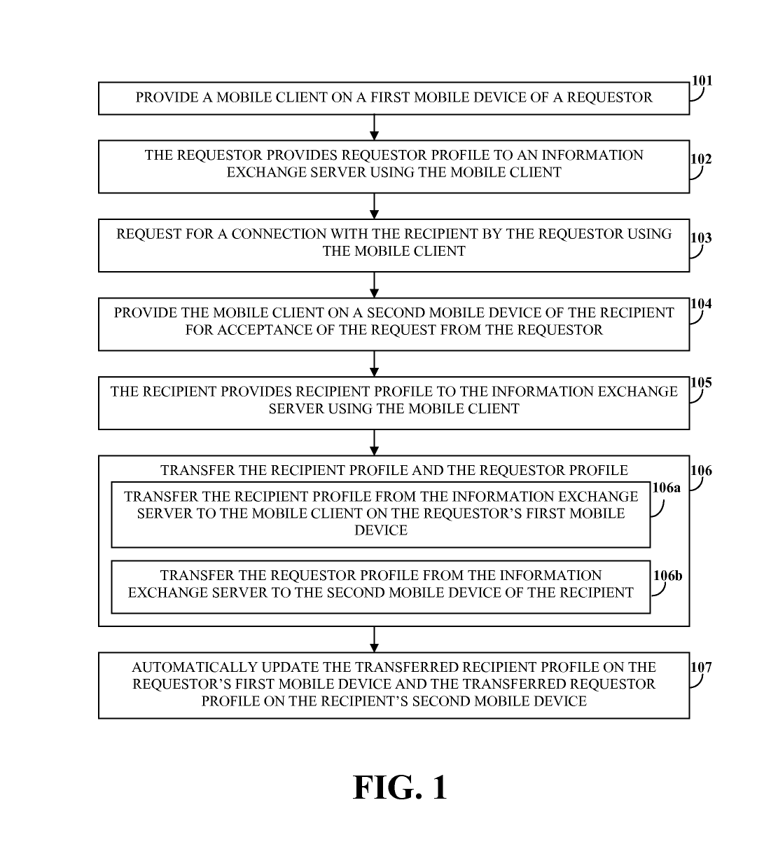

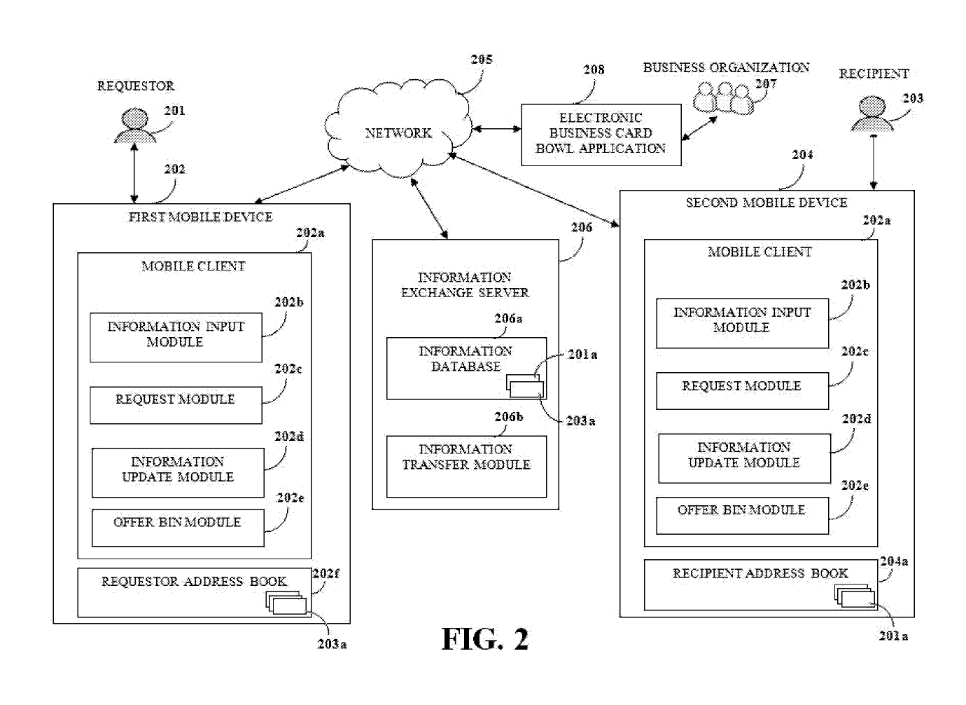

FIGS. 1-2 illustrate a method and system of managing mobile exchange of profile information between a requestor 201 and a recipient 203. The profile information may comprise user name, contact numbers, email addresses, visual images, audio content, job profile, location addresses, and social media information and links, etc of the requestor 201 and the recipient 203 respectively. An electronic business card on a mobile device may collectively represent the profile information on a mobile device of the requestor 201 and the recipient 203 respectively.

Although the description refers to the requestor 201 as the party asking for the recipient's 203 profile information, it is to be understood that the requestor 201 and the recipient 203 may change roles, such that the recipient 203 may be the one asking for the requestor's 201 profile information. However, for clarity and to avoid confusion, the description will refer to the requestor 201 as the one asking for profile information from at least one or more other recipients 203.

The method disclosed herein provides 101a mobile client 202a on a first mobile device 202 of the requestor 201. The requestor 201 may download and install the mobile client 202a from a host website via a network 205 onto the first mobile device 202. The mobile client 202a is compatible for installation on mobile devices working on different technological platforms and operating systems, for example, Java, Symbian, Windows, Mac, iPhone, Linux, Unix, Palm, etc.

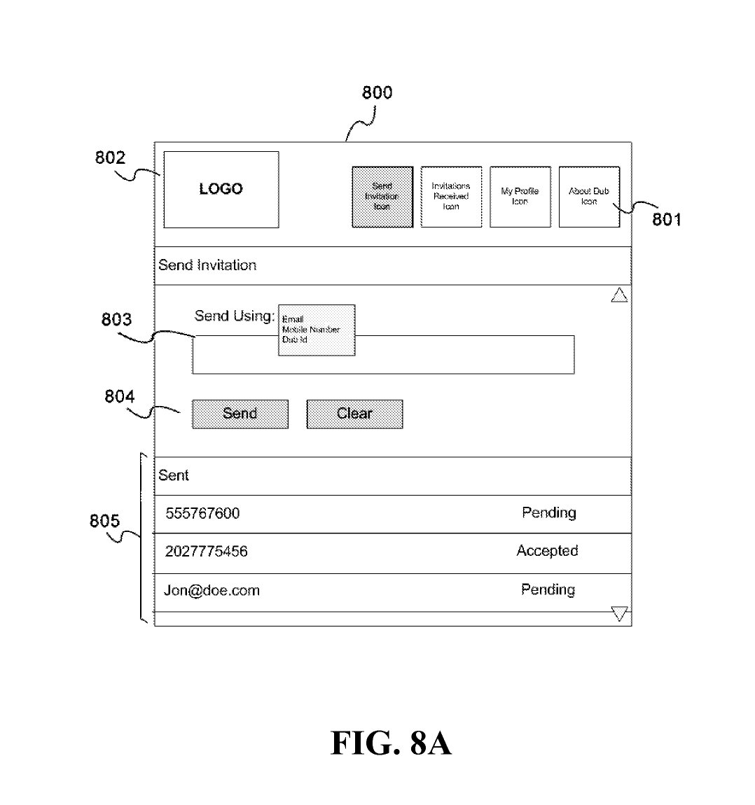

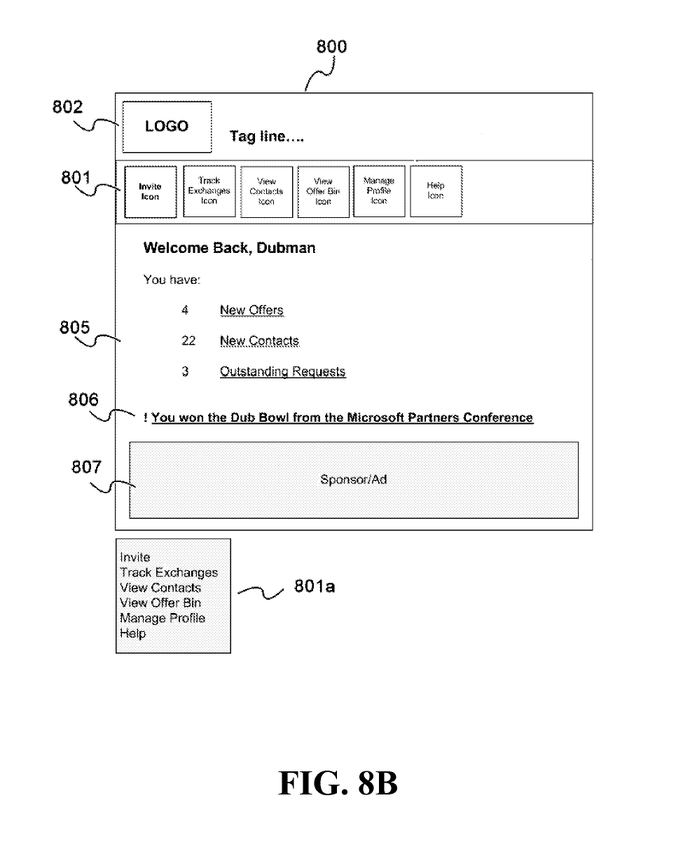

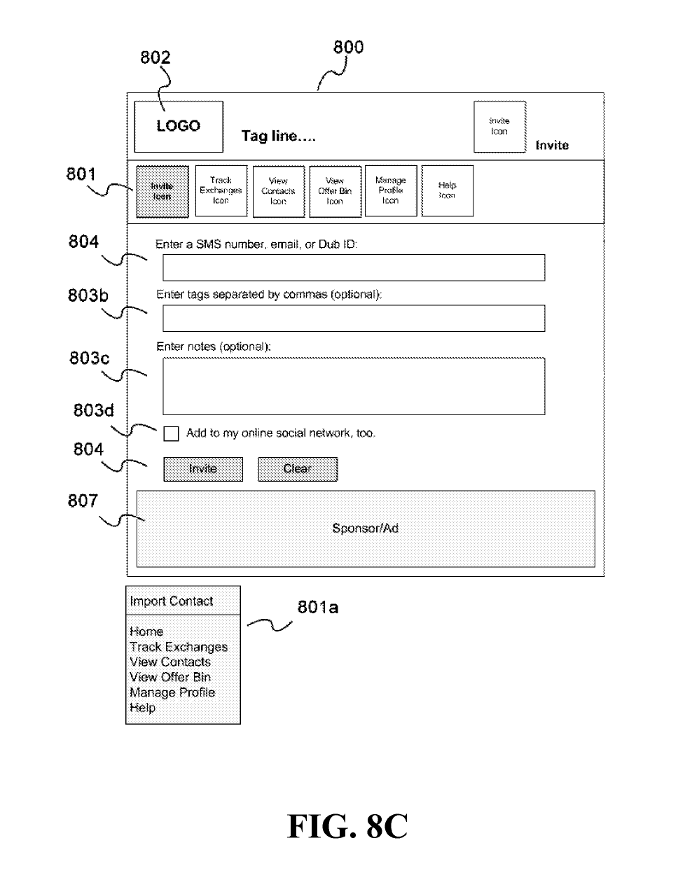

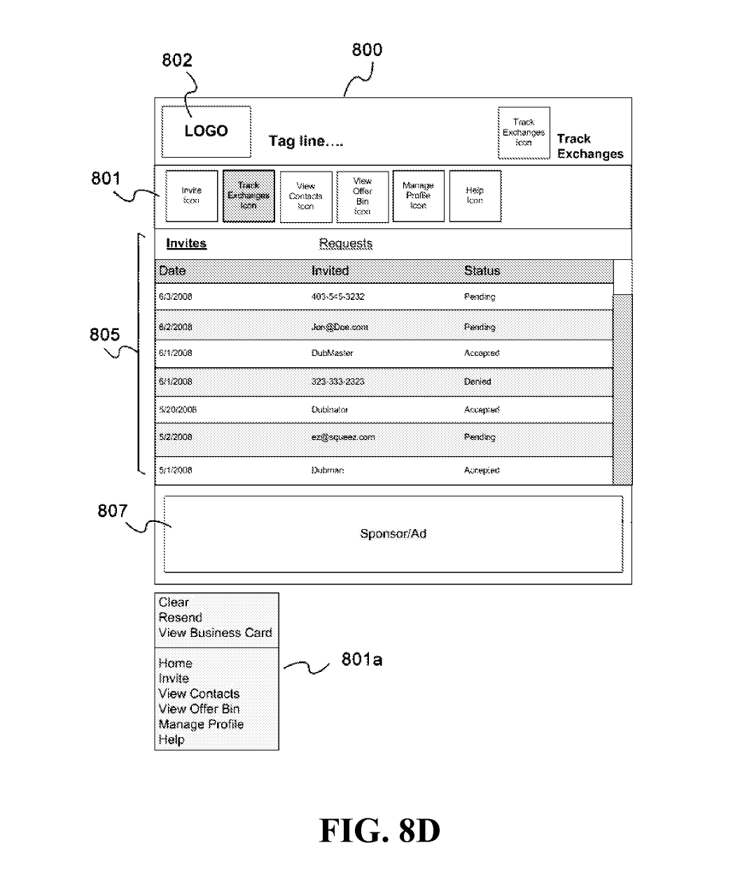

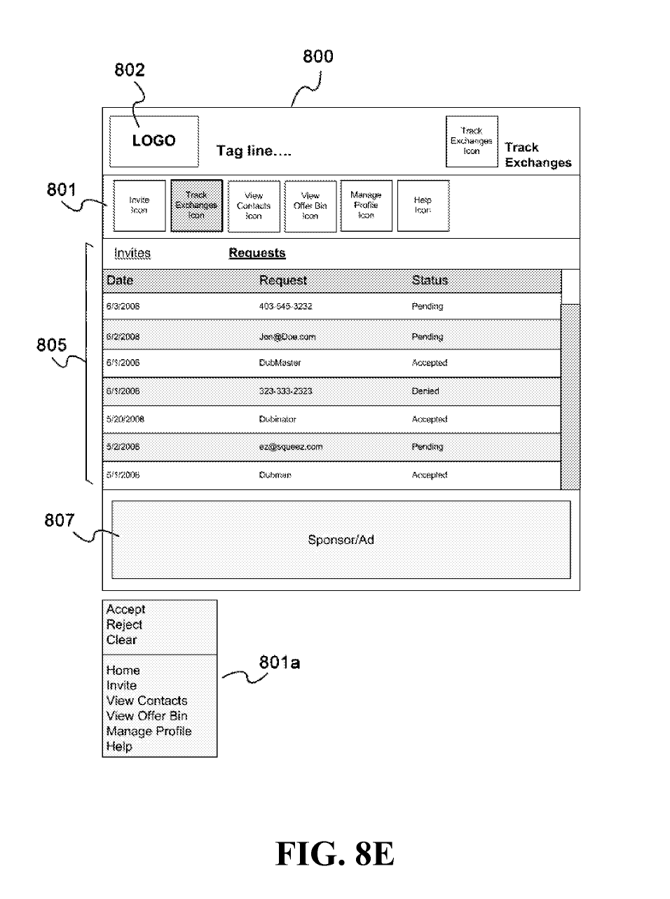

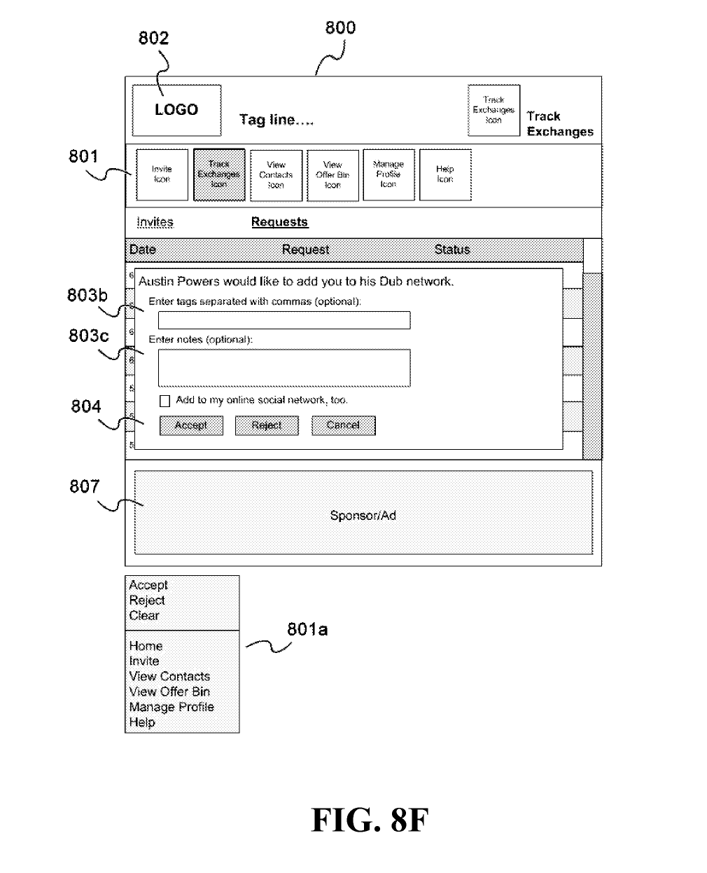

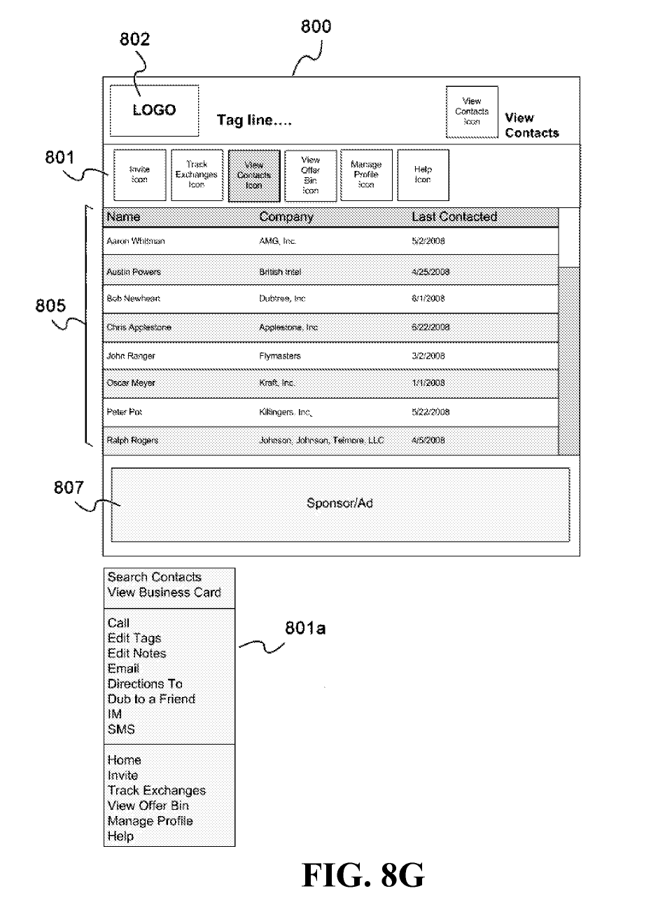

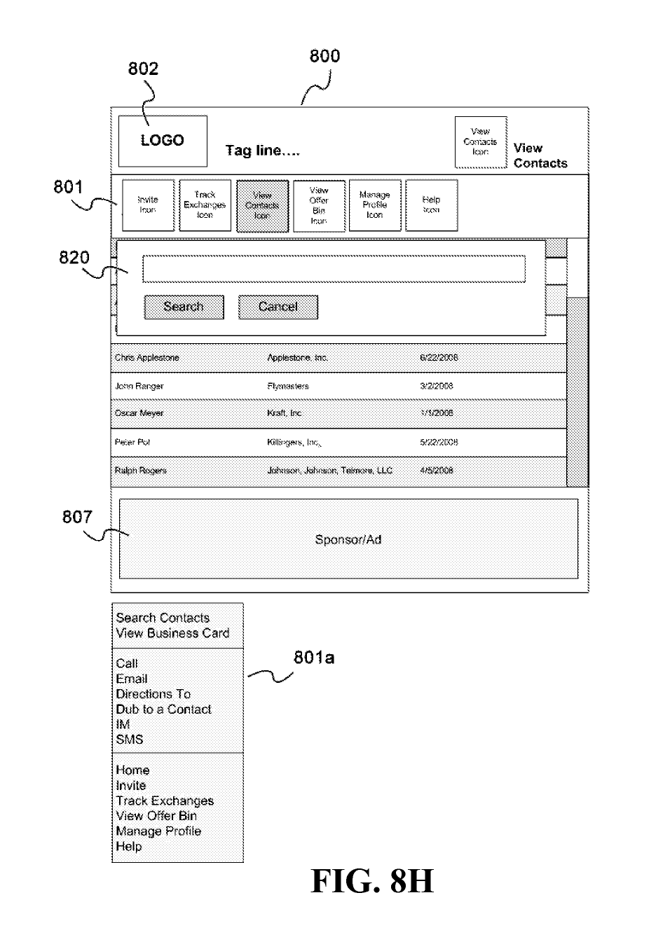

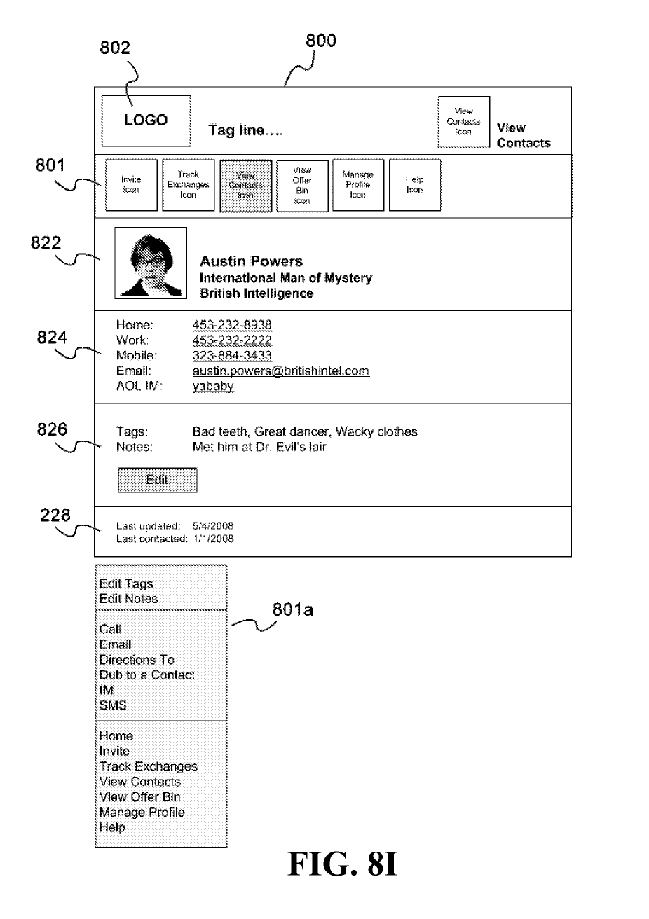

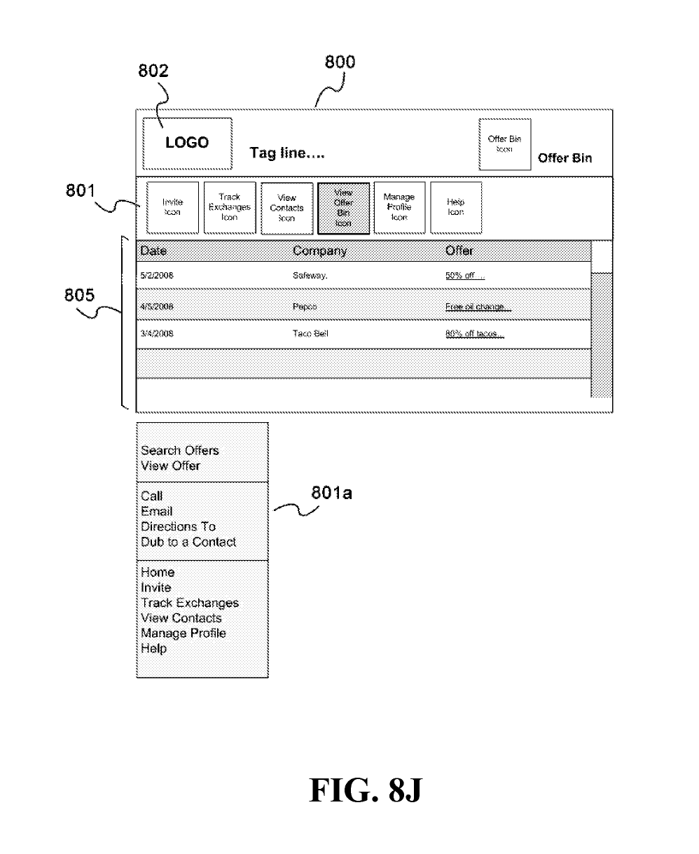

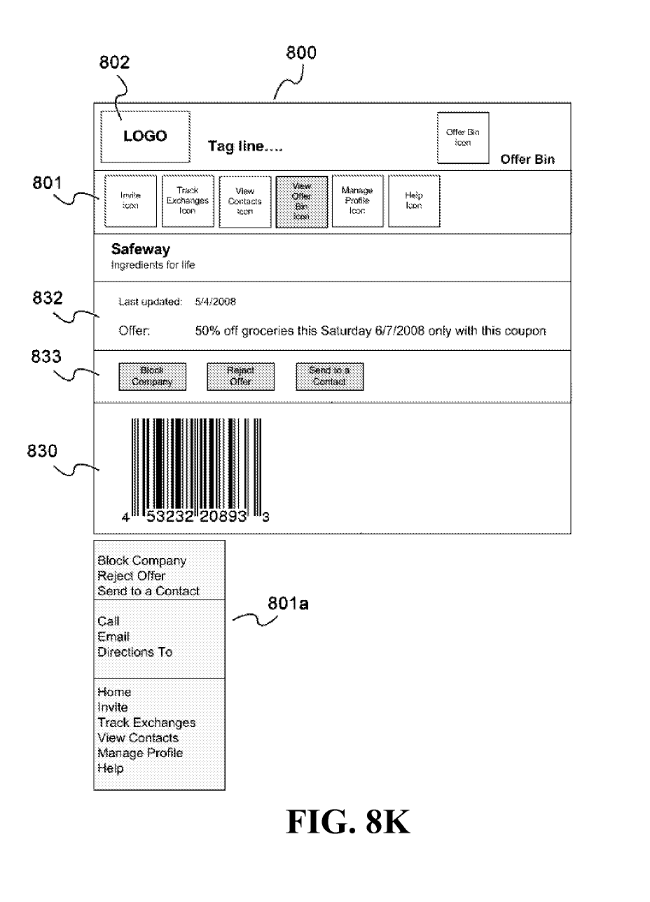

The requestor 201 then provides 102 requestor profile 201a to an information exchange server 206 of the host website through the mobile client 202a via the network 205. The requestor 201 may also use browser based computing devices to provide the requestor profile 201a on the host website on the internet directly. The requestor 201 then requests 103 for a connection with the recipient 203 through the information exchange server 206 using the mobile client 202a as shown in the user interface 800 of FIG. 8A. At box 803, the requestor 201 may generate and send (at box 804) the request as a short message service (SMS), an electronic mail (email), or through push notification (if the recipient is registered in the system the requestor may use the user ID of the recipient 203 instead of the SMS or email) via the information exchange server 206 to a second mobile device 204 of the recipient 203 using the mobile client 202a as illustrated in FIG. 8A. The status of the various generated requests may be shown at box 805. Various types of information may be included in the user interface 800, such as active screen information (box 801), or logos and or other types of advertisement information (at boxes 802, 807).

The request may be described as an “identification code” or ID code that initiates a set of instructions to be performed and controlled by the information exchange server 206. Specifically, the identification code might contain an access code along with a key or hash function, a call to the specific API or API function, and/or any other type of required data to execute the appropriate function or functions. The function might consist of a profile transfer request to or from the recipient 203 or the requester 201, or any other function the user could perform through the mobile application. In one example, the access code and key may be a unique code and key which is established or loaded onto the mobile device 202, 204 when the user first registers, logs in, or uses the mobile client on the mobile device 202, 204. In such an embodiment, the mobile device may provide the access code and key, and/or associated data information, to all transmissions along with the API request and appropriate data to provide the identity of the device, the user, and the appropriate instructions. The access code and key might also be a user name and password which are passed to the information exchange server 206 along with the API or instruction request and related data.

The identification code may be associated with various types of information, including but not limited to an access code, a key, a hash function, an API request or call, data required to perform the API request, information about the mobile device, location based information, a user, a user's preferences, the mobile device capabilities, profile information of a user, a social or professional event, a group, a centralized group coordinator, and any other type of data in accordance with this invention.

Another important aspect about the present invention is the ability for the system to obtain, pull, or retrieve information about the mobile device used by the requestor 201 or the recipient 203. Such information might include the type of mobile device, platform and version, carrier information, profile information, and location based information. The system will know if a user changes mobile devices, the capabilities of the mobile device, if the user had updated software, or changes information about their mobile device. The profile and location data can be used to identify users about software upgrades, version conflicts, and location based services including internet access to GPS location of lost mobile devices.

In more detail, it is to be understood that various types of information may be made available to the information exchange server 206 during signaling in accordance with systems and methods of this invention, similar to the information exchanged when a mobile device registers (either as a push or a pull inquiry) with its serving network. At registration, and likewise when as here the mobile device signals into the network 208, information about the particular device being used, such as the location of the mobile device, the user's profile, user preferences, and the like, may be shared with the information exchange server 206. For various reasons, this information may be used by the information exchange server 206 to coordinate the type of messaging that should be prepared and sent to an intended mobile device recipient. For example, one user, and/or serving network for the mobile device of the user, may set a preference to receive SMS messages on his mobile device, while another user may prefer to receive email messages on their mobile device or at another device location. The information exchange server 206 is equipped to handle such translation and requests appropriately for the particular preference appropriately.

An “event” may be a one-to-one communication encounter, a one-to-many communication encounters, a social or personal meeting, and other engagement or environment in which contact profile information is generally exchanged amongst various people. Although the request is described above as a SMS or an email to communicate back to the information exchange server 206, it is to be understood that any type of push or messaging protocol may be employed, including but not limited to, MMS, USSD, a dedicated short code, and or any other suitable messaging protocol capable of sending a request. The requestor 201 may also use other communications means, for example, infrared data transfer, Bluetooth, WiFi or WiMax, etc, to send the request to the recipient's 203 second mobile device 204.

FIG. 8A depicts an exemplary user interface 800 on a first mobile device 202. The user interface 800 includes selectable profile indicators 801 and a space for a logo 802. As shown, the “Send Invitation Icon” is selected at 801. A data entry box 803 is provided to insert the email, mobile number, a user id, or a message, and/or other types of information, and action buttons 804 are provided to send or clear the message in the data entry box 803. Various status boxes 805, 801a are illustrated depicting the status of various invitations. The various FIGS. 8B-8K show similar user interfaces 800 including similar labels and indicia.

The information exchange server 206 then provides 104 the mobile client 202a on the recipient's 203 second mobile device 204 for acceptance of the request from the requestor 201. The information exchange server 206 may provide a hyperlink in an SMS or in an email sent by the requestor 201. The recipient 203 may click on the hyperlink in the SMS or the email for downloading the mobile client 202a on the recipient's 203 second mobile device 204. The recipient 203 may then download and configure the mobile client 202a on the recipient's 203 second mobile device 204. The recipient 203 then provides 105 the recipient profile 203a to the information exchange server 206 through the mobile client 202a on the recipient's 203 second mobile device 204.

The recipient 203 may accept the request from the requestor 201 through information exchange server 206 on the recipient's 203 second mobile device 204 as illustrated in FIG. 8F. On acceptance of the request by the recipient 203, the information exchange server 206 may establish the connection between the requestor's 201 first mobile device 202 and the recipient's 203 second mobile device 204. In one embodiment, the information exchange server 206 may establish the connection between the requestor 201 and the recipient 203 via the SMS or the email before the mobile client 202a is downloaded and configured by the recipient 203 on the recipient's 203 second mobile device 204.

On acceptance of the request from the requestor 201 by the recipient 203, the information exchange server 206 transfers 106 the recipient profile 203a and the requestor profile 201a to the mobile client 202a on the requestor's 201 first mobile device 202 and the recipient's 203 second mobile device 204 respectively. The information exchange server 206 first transfers 106a the recipient profile 203a to the requestor's 201 first mobile device 202. The information exchange server 206 then transfers 106b the requestor profile 201a to the mobile client 202a on the recipient's 203 second mobile device 204. Although the exchange of each of the requestor's 201 and recipient's 203 profile information 201a, 203a is being sent from the information exchange server 206, it is to be understood that profile information 201a, 203a may be sent directly between the first mobile device 202 and the second mobile device 204, without having to go through the information exchange server 206. In such instances, copies of the profile information 201a, 203a may be sent back to the information exchange server 206 to update the information exchange server's 206 profile information 201a, 203a records.

The mobile client 202a on the requestor's 201 first mobile device 202 may store the transferred recipient profile 203a of the recipient 203 as a recipient business card. The mobile client 202a on the recipient's 203 second mobile device 204 may also store the transferred requestor profile 201a as a requestor electronic business card. For example, the mobile client 202a on the requestor's 201 first mobile device 202 may update a requestor address book 202f on the requestor's 201 first mobile device 202 by storing the electronic business card of the recipient 203 in the requestor address book 202f.

The mobile client 202a then automatically updates 107 the transferred recipient profile 203a on the requestor's 201 first mobile device 202 and the transferred requestor profile 201a on the recipient's 203 second mobile device 204 based on changes made to the recipient profile 203a and the requestor profile 201a by the recipient 203 and the requestor 201 respectively. The recipient 203 may make changes to the recipient profile 203a on the information exchange server 206 using the mobile client 202a on the recipient's 203 second mobile device 204. The recipient 203 may make the changes to the recipient profile 203a due to changes in one or more of job profile of the recipient 203, address of the recipient 203, phone number of the recipient 203, email address of the recipient 203, or any information or data stored or included in the recipient profile.

If the recipient 203 makes changes to the recipient profile 203a on the information exchange server 206, the information exchange server 206 may automatically transfer the changes made by the recipient 203 to the mobile client 202a on the requestor's 201 first mobile device 202. The automatic transfer may be in real time or near real time or pushed at logical intervals. For example, the mobile client 202a on the requestor's 201 first mobile device 202 and the information exchange server 206 may have a persistent internet protocol (IP) connection. The requestor 201 may then subscribe to receive the changes made by the recipient 203 automatically through the information exchange server 206 in real time. The mobile client 202a on the requestor's 201 first mobile device 202 may then automatically update the transferred recipient profile 203a on the requestor's 201 first mobile device 202 with the changes made by the recipient 203 to the recipient profile 203a. The mobile client 202a on the requestor's 201 first mobile device 202 may also automatically update the electronic business card of the recipient 203 with the changes to the recipient information in the requestor address book 202f of the requestor's 201 first mobile device 202. In addition, rather than a full time connection or periodic request, the system may employ a push technology or ping technology which acts when a profile is updated. The exchange server 206 upon receiving updated profile information would trigger an automatic push of the new information to the mobile device, with or without notification, or might ping the mobile device to accept the updated information.

Similarly, if the requestor 201 makes changes to the requestor profile 201a on the information exchange server 206, the mobile client 202a on the recipient's 203 second mobile device 204 may also receive the changes from the information exchange server 206. The mobile client 202a on the recipient's 203 second mobile device 204 may then automatically update the transferred requestor profile 201a on the recipient's 203 second mobile device 204 automatically with the changes made by the requestor 201 to the requestor profile 201a. The mobile client 202a on the recipient's 203 second mobile device 204 may also automatically update the electronic business card of the requestor 201 with the changes to the recipient information in the recipient address book 204a of the recipient's 203 second mobile device 204. The requestor 201 and the recipient 203 may also update one or more personal and business contacts selectively on the requestor's 201 first mobile device 202 and the recipient's 203 second mobile device 204 respectively. The mobile client 202a on the requestor's 201 first mobile device 202 and the recipient's 203 second mobile device 204 may also send requests to the information exchange server 206 at predefined intervals to automatically receive the changes to the recipient profile 203a and the requestor profile 201a respectively. In addition to the mobile client 202a transferring changed or updated contacts onto the requestor's 201 first mobile device 202 and the recipient's 203 second mobile device from the information exchange server 206, the mobile client 202a may also download new and changed profiles from the information exchange server 206 onto the requestor's 201 address book 202f and the recipient's 204 address book 204a, respectively.

The requestor 201 may have access to the recipient profile 203a of the recipient 203 on one or more of the social network websites. The requestor 201 may then import and store the recipient profile 203a of the recipient 203 from the social network websites directly onto the requestor's 201 first mobile device 202 through the mobile client 202a on the requestor's 201 first mobile device 202. The information exchange server 206 may then automatically establish a connection between the requestor 201 and the recipient 203 when the requestor 201 imports and stores the recipient profile 203a on the requestor's 201 first mobile device 202 using the mobile client 202a. The recipient 203 may also import and store the requestor profile 201a of the requestor 201 from the social network websites directly onto the recipient's 203 second mobile device 204 through the mobile client 202a on the recipient's 203 second mobile device 204. The mobile client 202a on the requestor's 201 first mobile device 202 may also add (box 803d of FIG. 8C) or update the recipient profile 203a of the recipient 203 on one or more social networking websites on the internet with the transferred recipient profile 203a. The mobile client 202a on the recipient's 203 second mobile device 204 may also add or update the requestor profile 201a of the requestor 201 on one or more social networking websites on the internet with the transferred requestor profile 201a.

The first mobile device 202 and the second mobile device 204 may be any of the commercially available mobile phones and smartphones, for example, Blackberry, Palm, Nokia, Ericcson, Samsung, Android, iPhone, and/or any other commercially available mobile phone now known or later discovered in accordance with this invention. The requestor 201 and the recipient 203 may further create multiple profiles on the host website via the internet or via the mobile client 202a to provide context specific information. For example, if the recipient 203 is a friend or a family member of the requestor 201, the requestor 201 may create a personal profile to provide personal information to the recipient 203. If the recipient 203 is a business associate of the requestor 201, then the requestor 201 may create a business profile to provide business information to the recipient 203. The requestor 201 and the recipient 203 may tag context specific information (boxes 803b, 803c of FIG. 8C) along with the requestor profile 201a and the recipient profile 203a respectively as illustrated in FIG. 8C. The context information may comprise the location where the contact was made, the time the contact was made, shared interests and/or groups with the contact, personal and business notes, links to clients, and any other type of information intended to be memorialized about the contact. For example, the context information may comprise information noting the recipient 203 as a smart sales person or a known manager of a company. The mobile client 202a may also capture an image or image data such as a picture of the recipient to add to the recipient profile 203a.

The mobile client 202a may capture geographic information like date, time, and global positioning system (GPS) coordinates at the time of providing the requestor profile 201a and the recipient profile 203a by the requestor 201 and the recipient 203 respectively. The mobile client 202a may then send the captured date, time, and GPS coordinates to the information exchange server 206. The information exchange server 206 may store the requestor profile 201a and the recipient profile 203a provided by the requestor 201 and the recipient 203 respectively. The information exchange server 206 may also store the geographic information sent by the mobile client 202a.

The method disclosed herein further provides an electronic business card bowl application 208 for a business organization 207 with a business profile provided on the information exchange server 206 for collecting the profile information provided by customers using the mobile client 202a via the information exchange server 206. The method disclosed herein may provide an exclusive online business service to the business organization 207 to set up the electronic business card bowl application 208 on a business website of the business organization 207. The electronic business card bowl application 208 may store the profile information provided by the customers on a business website of the business organization 207. For example, the business organization 207 may receive profile information from the customers through the electronic business card bowl application 208 via the information exchange server 206. The business organization 207, for example, a chamber of commerce, business alliance, an association, a membership or club, a restaurant, a garment shop, a retail outlet, etc may then utilize the electronic business card bowl application 208 for ease of profile information transfer to attendees and for promotions of the business organization 207. For example, all the attendees of a given event or conference of the organization may be provided in a group or organization listing in the database 306 which would be available to other attendees through the information exchange server 206. Further, the business organization 207 may utilize the list of attendees such as for a contest offering prizes to the attendees or customers using the profile information of the attendees or customers stored by the electronic business card bowl application 208 through the information exchange server 206. An attendee or customer may send their profile to the business organization 207 though the mobile client 202a on a mobile device of the customer via the information exchange server 206 to avail business offers offered by the business organization 207. The business offers may comprise exchange of profile information of other attendees, notification mailing list entry, contest for free lunch, discount coupons, etc offered by the business organization 207.

The mobile client 202a enables the requestor 201 and the recipient 203 to view the user interface 800 of the mobile client 202a as illustrated in the status box 805 in FIG. 8B, send the requests, accept the requests, view status of the sent requests or invites as illustrated in the “Track Exchanges Icon” user interface 800 shown in FIG. 8D. FIG. 8E shows a user interface 800 in which the requests received may be viewed in status box 805 as illustrated in FIG. 8E. The mobile client 202a also enables the requestor 201 and the recipient 203 to view list of contacts as illustrated in the user interface 800 illustrated in FIG. 8G. Using search query box 820 within the user interface 800, FIG. 8H illustrates how a particular contact may be searched for within a list of contacts, as well as to view and update the profile information, etc. In the user interface 800 shown in FIG. 8I, the mobile client 202a also enables the requestor 201 and the recipient 203 to view the profile information 822 of a particular contact, e.g., Austin Powers. As shown in this exemplary user interface 800, the contact profile information includes various types of information. In a first contact information identification box 822, along with the contacts name, company and position may be displayed. In a second box 824, various phone numbers, email, social networks and IM addresses may be displayed. In another box 826, other contextual information and private notes may be provided about the contact. This profile information may be accessed via the Internet and/or through the mobile client 202 on a requestor mobile device 202. At box 228, information about recent updates and last contacts with the person may be provided. Any one of the boxes, and or information in any of the FIGS. 8A-8K may be expanded to include an extensible set of icons and customizable links. As depicted in the user interface 800 shown in FIG. 8J, business offers sent from advertisers may be viewed, and accept or rejected. FIG. 8K depicts another exemplary view for the user interface 800 in which additional business offers sent from advertisers may be reviewed in status box 805.

The requestor 201 and the recipient 203 may also use browser based computing devices to access an user interface similar to the mobile client 202a provided on the host website of the information exchange server 206 via the internet by registering on the host website and logging in. The mobile client 202a on a mobile device may maintain a log of calls, emails, text messages, etc. sent from the mobile device of the user The information exchange server 206 may also store the log of calls, emails, text messages, etc. sent from the mobile device of the user in an information database 206a of the information exchange server 206. The mobile client 202a may provide the user an optional offer bin facility for receiving advertisements from advertisers on the user's mobile device. The mobile client 202a may enable the user to send the profile information with the other users without disclosing phone number of the user. The mobile client 202a also enables the user to maintain a back up of the profile information of the other users on the user's mobile device in the information database 206a of the information exchange server 206. The user may retrieve the back up of the profile information of the other users from the information database 206a through the information exchange server 206 in case of loss or damage of the user's mobile device.

FIG. 2 illustrates a system of managing mobile exchange of profile information between a requestor 201 and a recipient 203. The system disclosed herein comprises a mobile client 202a provided on a requestor's 201 first mobile device 202, a recipient's 203 second mobile device 204, and an information exchange server 206 connected via a network 205. The mobile client 202a comprises an information input module 202b, a request module 202c, information update module 202d, and an offer bin module 202e. The information input module 202b enables the requestor 201 and the recipient 203 to provide requestor profile 201a and recipient profile 203a respectively to an information exchange server 206. The request module 202c requests for a connection with the recipient 203.

The information exchange server 206 comprises an information database 206a and an information transfer module 206b. The information database 206a stores the requestor profile 201a and the recipient profile 203a provided by the requestor 201 and the recipient 203 respectively through the mobile client 202a. The information database 206a also stores a log of calls, emails, and text messages sent from a mobile device using the mobile client 202a. On acceptance of the request for the connection from the requestor 201 by the recipient 203, the information transfer module 206b transfers the recipient profile 203a from the information exchange server 206 to the requestor's 201 first mobile device 202. The information transfer module 206b then transfers the requestor profile 201a to the mobile client 202a on the recipient's 203 second mobile device 204. The information update module 202d of the mobile client 202a on the first mobile device 202 automatically updates the recipient profile 203a and the requestor profile 201a transferred from an information exchange server 206 on the requestor's 201 first mobile device 202 and recipient's 203 second mobile device 204 respectively based on changes made to the recipient profile 203a and the requestor profile 201a by the recipient 203 and the requestor 201 respectively. The mobile client 202a may update an electronic business card of the requestor 201 and the recipient 203 in a requestor address book 202f of the requestor's 201 first mobile device 202 and a recipient address book 204a of the recipient's 203 second mobile device 204 respectively. The offer bin module 202e receives advertisements from advertisers on the mobile device using the mobile client 202a.

In addition, the system further comprises a backup module. The backup module enables the requestor 201 and recipient 203 to store or backup the mobile phone contacts of the requestor 201 and/or recipient 203 on a backup information database. The backup module also eliminates duplicates in the requestor's 201 and recipient 203 address book 202f, 204a found on the requestor's first mobile device 202 and recipient second mobile device 204 respectively. The requestor 201 and recipient 203 may backup their mobile phone contacts by either manually starting the backup module using the mobile client 202a, 202b or setting a schedule that automatically triggers the backup module. The system further employs unique identifiers which are associated with the requestor 201 and recipient 203. Corresponding unique identifiers are located in the backup information database such that a unified address book is created for the requestor 201 and a unified address book is created for the recipient 203. The unique identifier for the requestor 201 and the recipient 203 may be used to access their respective unified address book by using the internet on a computer or computer-based device. The backup information database may also include the information database 206a residing on the information exchange server 206.

The system disclosed herein further comprises an electronic business card bowl application 208. The electronic business card bowl application 208 collects profile information provided by customers via the information exchange server 206 on a business website of the business organization 207 hosted by a business organization server.

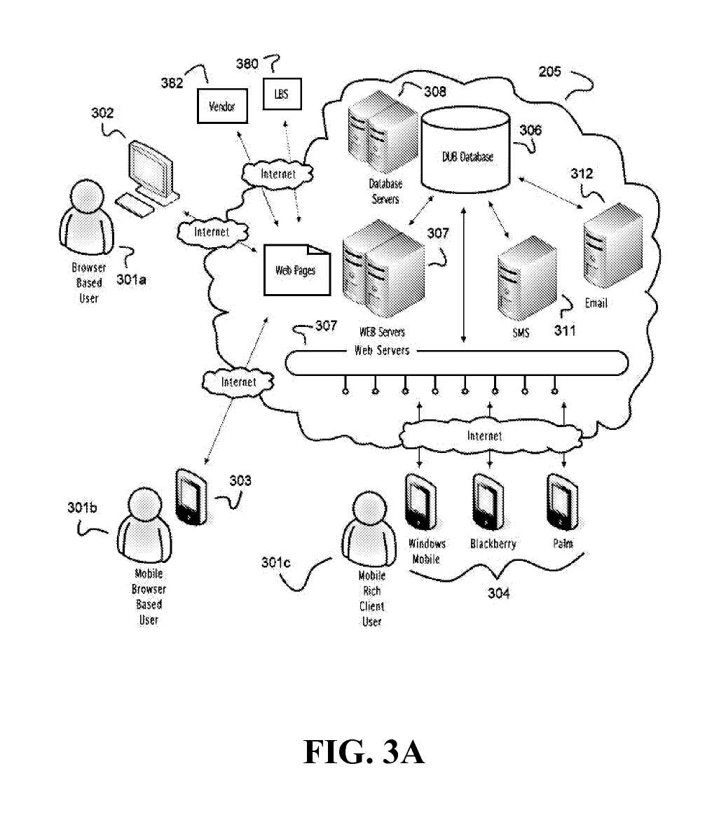

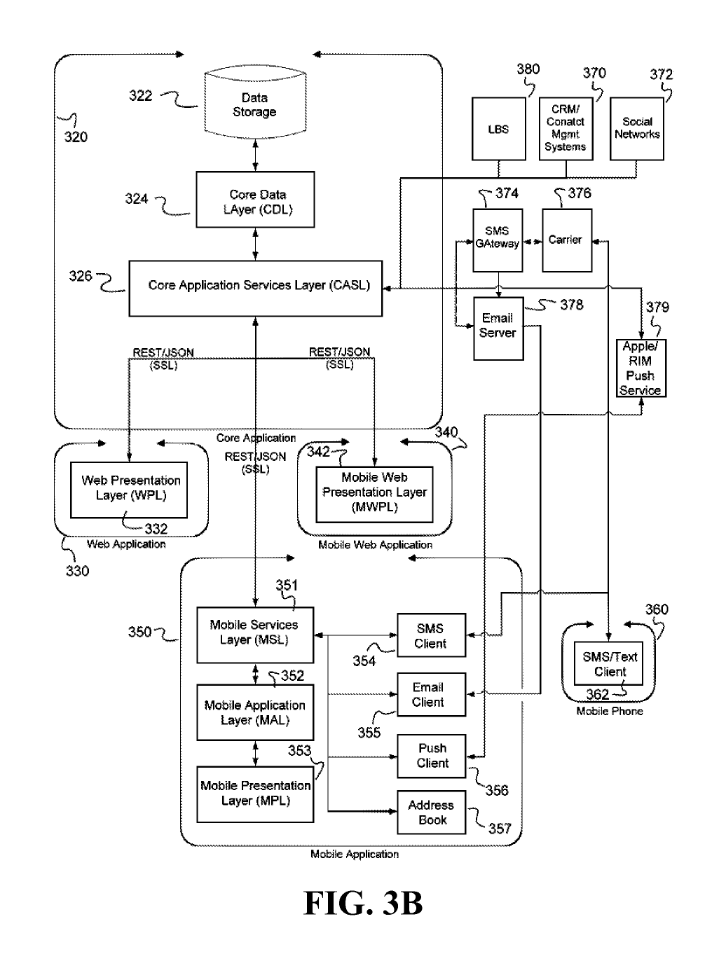

FIG. 3A depicts an exemplary illustration of an exchange of profile information between various computing devices via the network 205. As shown, a browser based user 301a is shown using a computing device 302, a mobile browser based user 301b is shown using a mobile device 303, and a mobile rich client user 301c is shown employing a smart phone 304 which may be connected through a web server 307 into one or more information exchange servers 308 via the network 205. Although each of the various computing devices 302, 303, 304 shown are connected through one of various users 301a, 301b, 301c interfaces, it is also within the scope of this invention to connect a mobile computing device into the information exchange servers 308 via a native user interface, and/or any other interface which does not require a web server 307. Although not specifically depicted, a mobile user (such as 301b) could be connected or interact with the system through use of SMS. In such an instance, the user would send an SMS message to one or more SMS codes with established instructions. For example, the mobile user 301b could send an SMS text to 38263: dubmejohn@myemail.com. The SMS message would be transmitted from the carrier to the system where it could be translated into http requests to interact with the API, servers 307, 308 and database 306 to execute the same functions and requests the user can employ through the mobile client 202a. In this instance, the instructions would be translated into an http request to interact with the API to transmit the user's profile to the recipient whose email is john@myemail.com.

Each of the users 301a, 301b, 301c interfaces may access data via a database server 308 from the information exchange servers 308 in a simple and clear format. According to this system, the addition of a new user interface can be integrated is an easy, suitable manner. As shown and in FIG. 3B, the architectural style is layered, and the logical architecture of the system is depicted from at least one mobile phone user interface down to the source database. It is to be understood that the layered architectural structure of this system may include more or less layers in accordance with this invention.

FIG. 3A depicts an exemplary logical system architecture illustration in accordance with this invention. The object of this architecture is to coordinate the transfer, extraction, storage and representation of data information to and from the existing legacy systems, the exchange servers of this invention, and the various computing devices 302, 303, 304 operated by the various users 301a, 301b, 301c. FIGS. 3A and 3B show a system including at least three different users 301a, 301b, 301c. The various interfaces may run on any one of, or many, number of different operating systems, including but not limited to Windows®, Linux, WAP, MIDP, Symbian, Pocket PC, and or any other platform now known or later discovered in accordance with this invention.

In FIG. 3A, the web servers 307 communicate with one or more storage databases, such as the database servers 308 and a proprietary database 306, such as herein named and shown “DUB Database.” The web servers 307 handle the HTTP protocol to enable the exchange of the profile information between the storage databases 306, 308, the browser-based user 301a, the mobile browser-based user 301b, the mobile rich client user 301c via the Internet. As previous described, the user could interact with the system through SMS or an SMS client on the mobile device send SMS messages to the network which are then converted into http requests. Likewise, the web servers 307 provide the interface capability for sending the email and/or SMS to the browser-based user 301a, the mobile browser-based user 301b, and the mobile rich client user 301c via the internet or the network 205 can be used to send SMS messages to mobile devices which are set to receive SMS through user preference or mobile device limitations. The web servers 307 also provide the capability of pushing updated application code or profile information to the browser-based user 301a, the mobile browser-based user 301b, and the mobile rich client user 301c via the internet.

In FIG. 3B, the mobile application 350 communicates into the core application 320. As depicted, the web application 330 and a mobile web application 340, are connected to and between the mobile application 350 and the core application 320. As shown, the web application 330 is composed of a web presentation layer (WPL) 332, and the mobile web application 340 is composed of a mobile web presentation layer (MWPL) 342. Both of these applications transform and represent the profile information in a manner in which the target mobile device can handle and eventually display the profile information on a user interface to the user.

According to this invention, it is to be understood the API's integrated herein provide both front end and back end APIs for integration. For front end integration, REST/JSON APIs and SDK may be provided for iPhone, Blackberry, Windows Mobile, Android, and other similar operating mobile devices. A Javascript library may also be available to integrate the systems and methods of this invention with Web-based interfaces. On the backend, this invention may integrate an asynchronous integration pipeline that ties outbound requests off its invitation, or connection process. Various pre-built providers (e.g., Salesforce, LinkedIn, Siebel, SugarCRM, Twitter) may be leveraged, or customized applications may be developed and integrated. Likewise, organizations can push data from their systems and the methods described in this invention enable data n information within the present invention to be pushed into other organization systems seamlessly.

Communication to and from the web application 330 and the web presentation layer (WPL) 332 may leverage representational state transfer (REST) as a preferred software architecture style for distributed hypermedia systems such as the World Wide Web. However, it is to be understood that any suitable architecture style may be implemented in accordance with this invention. As shown, the MIME type of the data supported by the web service is JSON. However, other suitable types may include, such as for example, XML, YAML, and or any other valid MIME type, now known or later contemplated in accordance with this invention. The semantics of REST notifications can easily be expressed in JSON format and are easy to parse and handle in the JavaScript environment. In this example, both of the UIs are browser-based, however, as mentioned before, it is also possible to choose to implement native or alternative wireless UIs, and/or the like which may not be browser based. Adding a new interface into this architecture could be accomplished through the addition of a new component at the presentation layer.

In the core application 320, various components are provided including data storage 322, a core data layer (CDL) 324, and a core application services layer (CASL) 326. Together, the various components provide the requisite logic and applications for processing the data and providing the profile information data to the user interface of the mobile devices 302, 303, 304 for the various users 301a, 301b, 301c.

In the mobile application 350, various other components are provided including a mobile services layer (MSL) 351, a mobile application layer (MAL) 352, and a mobile presentation layer (MPL) 353. The mobile services layer (MSL) 351 exchanges data information with an SMS client 354, an email client 355, a push client 356 and an address book 357 resident in the mobile application 350. It is to be understood that the mobile application 350 is adapted to host various additional clients not shown, albeit readily available. Together, the various layers 351, 352, 353 in the mobile application 350 include the requisite logic and support applications to process the data to and from the core application 320 in order to provide the profile information data to the various users 301a, 301b, 301c.

As shown in FIG. 3B, various services may communicate and exchange data information between the core application services layer 326 and the various clients 354, 355, 356 in the mobile application 350. By way of example, an SMS/Text client 362 resident on the mobile phone 360 communicates from a carrier 376 and through an SMS gateway 374 and/or through an email server 378 back into the email client 355 or the SMS client 354 within the mobile application 350. Alternatively, where a push type service 379 is used on a mobile computing device, such as with Apple and RIM products, text generated from the SMS text client 362 would be transmitted into the push client 356 within the mobile application 350. Although SMS and email are described in detail, it is to be understood that any type of suitable messaging format may be integrated in accordance with this invention, such as for example, short codes, MMS, USSD and/or any other suitable messaging service now known or later discovered.

In FIG. 3B, various other services are shown integrated into the systems and methods of this invention, such as, for example, the integration of a customer relationship management (CRM) contact management system 370, and/or the social networks 372. Data information gathered from the CRM contact management systems 370 and the social networks 372 may be sent into the core application services layer (CASL) 326. As shown, a location based service (LBS) 380 may be integrated into this invention. The LBS system 380 can provide information about the current position of a mobile device, as well as comparison and relative data of two mobile devices in proximity with each other. Various commercially available location based services may be used, such as for example, GPS, cell tower triangulation techniques, and any other suitable position locating technology.

The CRM contact management system 370 may be used in combination with the systems and methods of this invention in such a way that proprietary sales data information about a carrier's vendors and their partners may be securely shared with a proprietary sales person in the carriers 376 employ. In more detail, an aspect of this invention is to allow the carrier employee access to carrier's client database while under carrier's employ. However, carte blanche access may not be desired by the carrier. Consequently, certain identity information about the carrier's proprietary contact information may be masked so that if the employee should leave the carrier's employ, the carrier employee will be disconnected from acquiring access to the carrier client database, as well as lacking the ability to further access the carrier's client database. It is to be understood that various types of contact managements systems may be employed, such as, Siebel on Demand, Sales Force, as well as other contact management databases such as LinkedIn, MS Dynamics, Twitter, MySpace, and any other now known or later discovered contact management database.

The Location Based Service 380 element can operate in a variety of different ways. According to a first embodiment, a one-to-one social encounter may take place in which a requestor 201 and a recipient 203 encounter each other. Although the one-to-one social encounter has been described in detail with respect to FIG. 2, an additional aspect of this scenario is such that the location based service 380 may be integrated into the one-to-one encounter. This feature would allow a requestor 201 and a recipient 203 having a mobile client 202a installed on each of their phones respectively, to exchange profile information without the need to manually enter an email address, an identification code or a phone number. Employing the location based service 380, equipped for example with GPS or cell tower triangulation techniques, and within predetermined time interval, the information exchange server 206 may match and compare incoming exchange requests and present participating users with a list of available participating users. That is, where the requester 201 and a recipient 203 desire to share profile information 201a, 203a, both the requestor 201 and the recipient 203 may initiate the exchange of their profile information nearly simultaneously by, for example, selecting an assigned button on their respective mobile devices 202, 204. LBS 380 may then determine whether the requestor 201 and the recipient 203 are proximally close to each other and have both selected to share their profile information at approximately the same time with each other. The need to identify and associate a specific ID code with the encounter may not be necessary because the LBS 380 may determine that since the first mobile device 202 and the second mobile device 204 are substantially close to each other and have both selected to share profile information with another mobile device in close proximity to them, the likelihood that they are both requesting each other's profile information is highly certain. The information exchange server 206 can send a verifying message to both the first mobile device 202 and the second mobile device 204 requesting verification that they desire to exchange profile information with each other. Upon acceptance, the requestor profile 201a and the recipient profile 203a may then be exchanged with each other wirelessly. Although described as a one-to-one encounter, it is also possible to implement this process in a group setting where more than one mobile device is available to share each of their respective profile information amongst the group. Once the profile information has been accepted, the profile information will be shared and populated into the requestors address book 202f and the recipients address book 2041 respectively. According to this embodiment, there isn't a need to manually accept and/or transcribe the data manually into the address book.

According to another exemplary embodiment, a social group encounter may take place in which a requestor 201 and a number of recipients 203 may introduce themselves to each other and desire to exchange profile information, which is typically done by sharing business cards with each other. In this scenario, a single group identification code associated with the social event may be generated, tagged and associated with the particular social event. This scenario works well, for example, in situations where various unfamiliar participants attend a conference, a large meeting, and the like. The multiple attendees, herein, the requestor 201 and the various recipients 203, may share their profile information 201a, 203a with each other. Those in attendance at the event may wish to share their profile information with others at the social event. In operation, attendees at the social event may send their own profile information via the Internet or from a mobile client 202a resident on their mobile device into the information exchange server 206 via the group identification code. The information exchange server 206 will then compile all of the received profiles, match the requestors 201 with the recipients 203 and share the respected profile information 201a, 203a. An acceptance policy may be embedded such that an acceptance message is first sent to the requestor's 201 user interface prompting the requestor 201 to decline or approve the sharing of the profile information with the recipient. Any further modification to a particular profile in the group will be subsequently updated and revised at the information exchange server 206 and thereafter transmitted to all group member participants associated with that group identification code.

According to another exemplary embodiment of invention, a single group coordinator may be established who controls what profile information may be shared amongst a member's only directory defined group. The member's only directory may be accessed via the Internet or the mobile client 202a. The member's only directory may display only selected public information to the other members of the group. The individual members can exchange profile information from the member directory. The group can be un-moderated or moderated. An un-moderated group can be set up by one of the participants via the Internet or through the mobile client 202a by entering a group name and a group identification code associated with the member directory. By sharing this group identification code with others, the other participants can join the member directory group.

A moderated group is one in which a single group coordinator may be established who controls what profile information may be shared amongst the members only directory defined group. The group coordinator maintains management control of the profile information of each of the participants. The group coordinator can choose to selectively share information with each of the participants as a group and/or individually. For example, a university may be given the management control as a group coordinator. Various types of participants may subscribe to the university group, such as for example, alumni, current students, prospective students and faculty. Where an alumni participant may be concerned, all other alumni may share profile information amongst each other, the group coordinator would solely control the sharing of this information amongst the various alumni. Where a student is concerned, the group coordinator may selectively share profile information about faculty pertinent to that student's class schedule. Furthermore, where a prospective student may be concerned, the group coordinator may selectively share profile information about admission counselors and/or other information about programs or classes within the university. It is to be noted that the information tagged and shared to selected sub-groups within the university group may include, but is not limited to, personal profiles but may include data information about events, activities, programs, and the like. The group coordinator may also manage the permission of the user or organization to upload existing contact lists. Likewise, the group coordinator may manage member requests.

As part of the management of member requests, the group coordinator can setup “segments” which will allow them to associate members and tag them with words, phrases and/or terms they define. For example, the group coordinator may choose to tag a member to “employee”, “partner”, “vendor” or “recruiting candidate.” This feature is beneficial for marketing purposes. In addition, the group coordinator may customize the registration pages for new users and setup response emails, and/or other alerts when new users attempt to join. The various directories and tags may be tied to various back end systems in accordance with this invention.

It is to be understood that various types of controls and profiles may be created for a particular user. For example, a user may have a first business profile set up with his/her professional information and associated data. Likewise, the user may have a second social profile set up with his/her casual/social information and associated profile information data. Depending upon the environment in which the user is a participant, the user may selectively share one of the particular profiles with a recipient. Likewise, the user may opt-in to make all or portions of his/her personal contact information private to other users who already have their current profile information. Selectable security elements may be tied to various portions of the profile information which may be made visible or invisible to a recipient 203 of the profile information.

In the instance where a group coordinator or organization is managing various pieces of profile information, various privacy controls may be set that would apply to all members in that particular group, such as employees of the organization. The privacy controls can be applied to any profile field, such as in this example to email and phone numbers. Once the profile field is set to private, it cannot be viewed on the user's profile information. The group coordinator may apply privacy controls selectively to various requestors 201 and recipients 203 as it deems fit. Although the profile field for the email and/or phone number may be set to private and is hidden from the recipient 203, the recipient 203 of the profile information may still be able to email or call the person since the contact information including email address and phone number is still available to the information exchange server 206. A masked phone number and/or email may be used to communicate between the participants. The ability to communicate, and various other controls tied to the profile information, may be modified as desired. For example, if the requestor 201 decides later to prevent the recipient 203 to communicate with her, then the requestor 201 may select a “disable communication” profile field so that the recipient 203 can no longer call or email her.

According to another aspect of the invention, the information exchange server 206 may capture and include selective membership and financial information in a user's profile information, such as membership, loyalty and credit card account numbers. Examples of such membership and financial information include information typically fond on shopping and gym membership cards, shopping loyalty cards, frequent flyer accounts, bank debit and credit cards and the like. The compilation of this profile data information comprises a digital wallet. The advantage of the digital wallet is that the user would no longer have to carry multiple cards in a wallet but would have quick access and use of the information in a secure fashion.

By way of example, when a user wishes to make a financial transaction the user initiates the payment process by selecting the Vendor 382 (FIG. 3A) listed on the mobile device 202 and entering the amount of the transaction. The mobile device 202 transmits the vendor information, the transaction number, the amount of the transaction, and the user information to the information exchange server 206. The information exchange server 206 then pulls the financial information such as the credit card information of the user from the database 306 and transmits the information to the vendor 382. The vendor's system would then validate the transaction and send confirmation to the point of sale (POS) terminal at the location where the user is making the mobile payment to complete the transaction. Through use of the present invention, the user's information need not be displayed on their mobile device and all private information can be masked locally on the mobile device 202. Masking the private information thereby prevents theft from onlookers or anyone that sees, holds, or takes the user's mobile device 202.

The system of the present invention could also employ a peer to peer transaction by pushing contact information from the mobile device 202 to the POS terminal directly or through the information exchange server 206. In this embodiment, the POS terminal would receive a request from the mobile device which includes the user's profile. The Vendor 382, upon receipt of the request, would receive the transaction amount and user's profile information and would then connect to the network 205 to receive the user's financial credit card information. The vendor 382 would then approve the transaction or could transmit an SMS message or email message to the user's mobile device 202 to verify the transaction and amount.

The user may selectively separate and assign the credit cards in the digital wallet depending on whether the nature of the financial transaction to be made is one which is defined as a social or business related transaction. For example, at a business function, if a financial transaction is to be accomplished, the user may conduct a financial transaction with a credit account number related to her business account. Alternatively, the user may desire to make a financial transaction using a non-business related credit account number stored in her digital wallet in a social environment. The exchange of information between the requestors 201 mobile device 202 and the information exchange server 206 containing the digital wallet information may be performed using secured encrypted signaling of information at the time of the transaction throughout the system so as to prevent the sensitive financial information from being illegally accessed. Separate identification codes may be assigned to the various accounts numbers in the digital wallet and securely stored at the information exchange server 206, as well as in the requestors 201 mobile device 202.

As mentioned briefly above, identification codes may be associated with various types of membership accounts and rewards programs. The average person carries numerous membership and/or rewards cards on her person. Keeping track of these various membership cards can be cumbersome and monotonous. Thus, according to this invention, it is possible to associate one or many identification codes with each of the user's membership and/or rewards cards. By doing so, the need to carry various membership and/or rewards cards is eliminated.

Retrieval of a particular identification code may be achieved in numerous ways. In one example, the location based system 380 may be employed to automatically determine the location of the mobile device 202 of a user. The location based system 380 may determine the position of a mobile device 202 of a user in a number of commercially available ways, for example, using GPS, XY coordinates as registered by a cell tower, triangulation and/or any other suitable means for determining the location of the mobile device 202 of the user.

For example, FIG. 8K depicts an example user interface 800 that may be prompted as soon as the user enters and/or comes close to the location of the grocery store (i.e. Safeway). As shown, when the information exchange server 206 has acknowledged that a requestors 201 mobile device 202 is within a predetermined proximity of the Safeway, various information such as the offer 832 “50% off groceries this Saturday 6/7/2008 only with this coupon” is sent to the requestor's 201 mobile device 202 and displayed on the user interface 800. The requestor 201 may select from a variety of buttons 833 to block, reject or send the offer to another contact. Various types of information may be provided from the information exchange server 206 to the user interface 800 of the mobile device 202. A scanning barcode 830 may also be displayed as shown on the user interface 800 for use upon checkout from the grocery store. The advantage of providing this information accessible by the requestors 201 mobile device 202 is that the requestor 202 will not have to carry a variety of rewards card associated with numerous different establishments. Other membership and/or rewards programs may be utilized in a similar manner to the one described above, for example, walking into a gym, a requestor 201 may transmit an identification code with her mobile device 202 to the information exchange server 206, which in turn would transmit the appropriate profile information for that particular member to the Vendor 382 (as seen in FIG. 3A) through the network 205. The profile information returned from the information exchange server 206 could also be shared directly from peer to peer from the requestors 201 mobile device 202 to a receiving device at the gym, and/or a copy of the returned profile information may be directly sent to the gym establishment with a participating identification code and connected to the network 205. Likewise, purchases at these various establishments may also be made via the convenience of the requestors 210 mobile device 202 and an associated identification code. The benefit of the systems and methods of this invention is that personal and financial profile information may be securely embedded and masked on the requestor's mobile device 202 yet quickly and conveniently used at the appropriate establishments thereby eliminating the need to physically carry a wallet and/or purse. Leveraging this system, up-to-date contact profile information can be shared with various requesting parties such as, but not limited to, universities, organizations, billing agencies, and the like.

Another aspect of the present invention is to enhance the user's interactivity with their contacts and provide updates/feeds from various different social networks with full interactivity. The present invention enables the requestor 201 or the recipient 203 to set include within their profile all of their social media profile information including the following: LinkedIn, Salesforce, Siebel, Twitter, Dynamics, Facebook, Myspace, Orkut, Plaxo, Bebo, Friendster, FriendFeed, Xanga, Yahoo, SugarCRM, BlackberryPush, iPhonePush, Geo Location Service, Digg, Vimeo, YouTube, Flickr, loopt, Brightkite, Google Latitude, Yelp, Delicious, and IMs like Yahoo, AOL, Google Talk, MSA, iChat. Recipients of a profile could then decide manually or set their account to automatically follow or connect to social network accounts of new or updated profiles. For example, if a requestor 201 has a Twitter account identified in their profile the recipient could set their preferences to automatically follow the requestor on Twitter. The system and methods of the present invention can act as a central hub or messaging center for all communications and connections within the social spectrum relating to the participating contact or profile with which a user had connected.

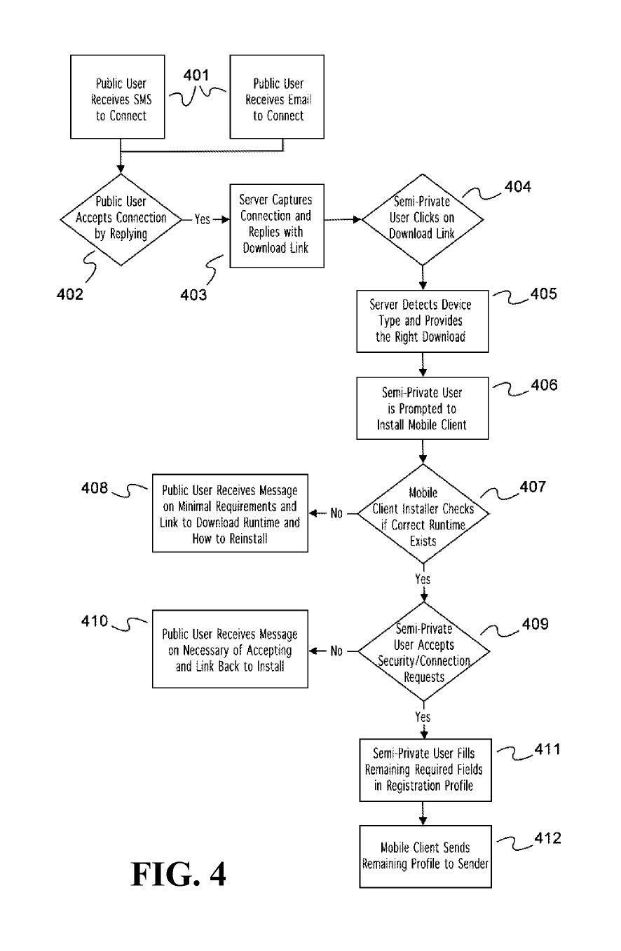

FIG. 4 exemplarily illustrates a flowchart of a process of a recipient 203, herein referred to as a “public user”, installing a mobile client 202a on a mobile device of the public user based on a request for connection by a requestor 201. The requestor 201 requests for a connection with the public user using the mobile client 202a on the requestor's 201 mobile device. The public user may receive 401 the SMS or the email from the requestor 201 on the mobile device through the information exchange server 206 via the internet. If the public user accepts 402 the request for connection by the requestor 201, the information exchange server 206 captures 403 the connection and replies with a download link for enabling the public user to download the mobile client 202a on the public user's mobile device. On acceptance of the request to download, the public user becomes a semi private user. The information exchange server 206 then provides minimal information stored in the information database 206a, required for the establishing the connection. The semi private user first receives the download link from the information exchange server 206 to download the mobile client 202a. The semi private user then clicks 404 on the link to initiate a mobile client installer application provided by the information exchange server 206 to download the mobile client 202a. The information exchange server 206 detects 405 the mobile technology on the semi private user's mobile device and provides an appropriate download of the mobile client 202a. The mobile client installer application then prompts 406 the semi private user to install the mobile client 202a.

The mobile client installer application checks 407 if correct runtime of the mobile client 202a exists while downloading the mobile client 202a. If the mobile client 202a does not have the correct runtime, information on minimal requirements for installation and link to download the proper runtime is provided 408 on the semi private user's mobile device. The mobile client installer application then installs the mobile client 202a on the semi private user's mobile device. The semi private user then accepts 409 connection requests made by the requestor 201 via the information exchange server 206 through the mobile client 202a installed on the semi private user's mobile device. The semi private user then fills 411 required information fields in the semi private user's registration profile on the mobile client 202a. On completion of the filling of the information fields by the semi private user in the semi private user's registration profile, the semi private user becomes a private user. The mobile client 202a then sends 412 the registration profile of the private user to the information exchange server 206.

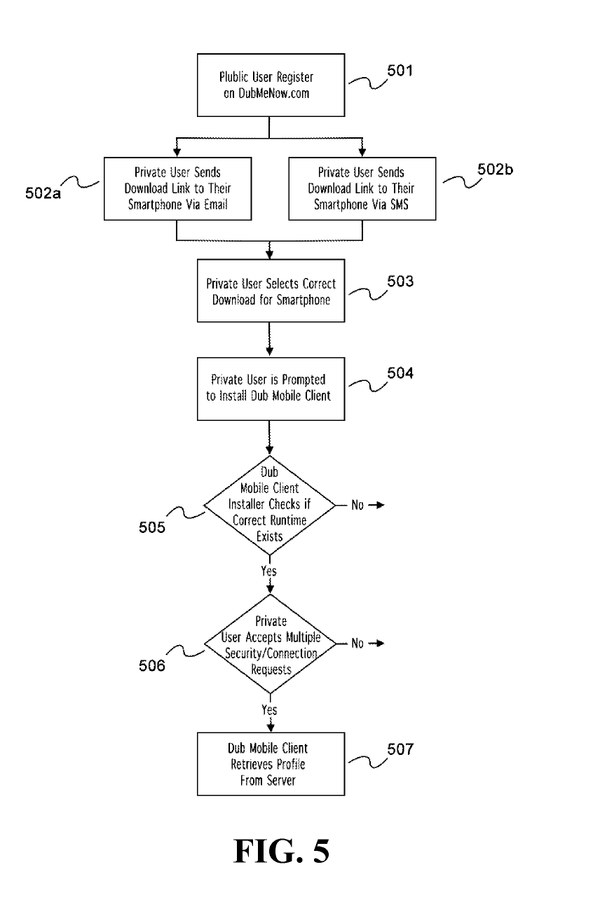

FIG. 5 exemplarily illustrates a flowchart of a process of a public user installing a mobile client 202a on a smartphone. The public user registers 501 on the host website implemented on the information exchange server 206. The public user then provides a user profile to the information exchange server 206 during the registration. On registration, the public user becomes a private user. The private user then sends 502a and 502b a hyperlink from the host website to the private user's smartphone via an email or an SMS to download the mobile client 202a on the private user's smartphone. On receiving the hyperlink, the private user then selects 503 correct download for the smartphone. The private user is then prompted 504 to install the mobile client 202a. A mobile client installer application then checks 505 if correct runtime of the mobile client 202a exists while downloading the mobile client 202a. If the mobile client 202a does not have the correct runtime, information on minimal requirements for installation and link to download the proper runtime is provided on the private user's smartphone. The mobile client installer application then installs the mobile client 202a on the private user's smartphone. The private user then accepts 506 multiple security and connection requests from the information exchange server 206 through the mobile client 202a installed on the private user's smartphone. The private user then retrieves 507 the private user's user profile from the information exchange server 206 using the mobile client 202a on the private user's smartphone.

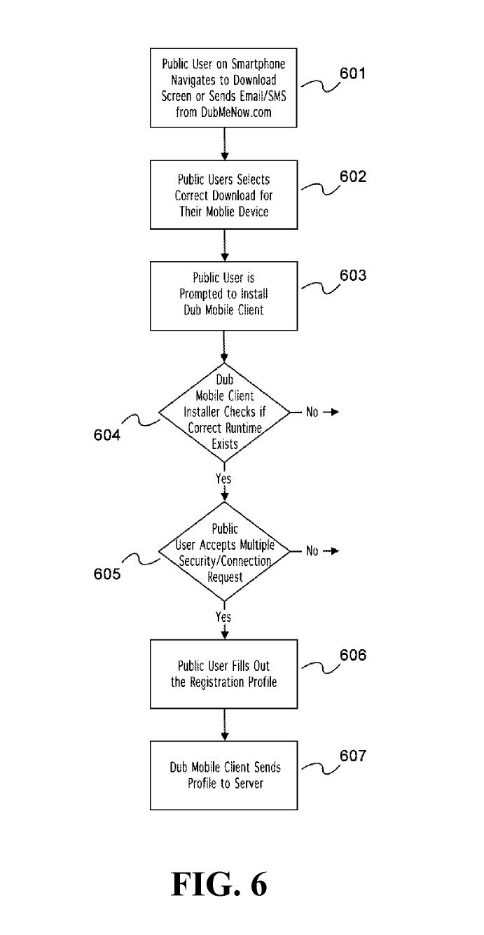

FIG. 6 exemplarily illustrates a flowchart of a process of a public user installing a mobile client 202a on a smartphone by accessing a host website from the public user's smartphone. The public user navigates 601 to a download mobile client screen from a host website using a web browser on the public user's smartphone. The public user then selects 602 correct download for the smartphone. The public user is then prompted 603 to install the mobile client 202a. A mobile client installer application then checks 604 if correct runtime of the mobile client 202a exists while downloading the mobile client 202a. If the mobile client 202a does not have the correct runtime, information on minimal requirements for installation and link to download the proper runtime is provided on the public user's smartphone. The mobile client installer application then installs the mobile client 202a on the public user's smartphone. The public user then accepts 605 multiple security and connection requests from the information exchange server 206 through the mobile client 202a installed on the public user's smartphone. The public user then fills 606 required information fields in the public user's registration profile using the mobile client 202a. The mobile client 202a on the public user's smartphone then sends 607 the registration profile to the information exchange server 206.

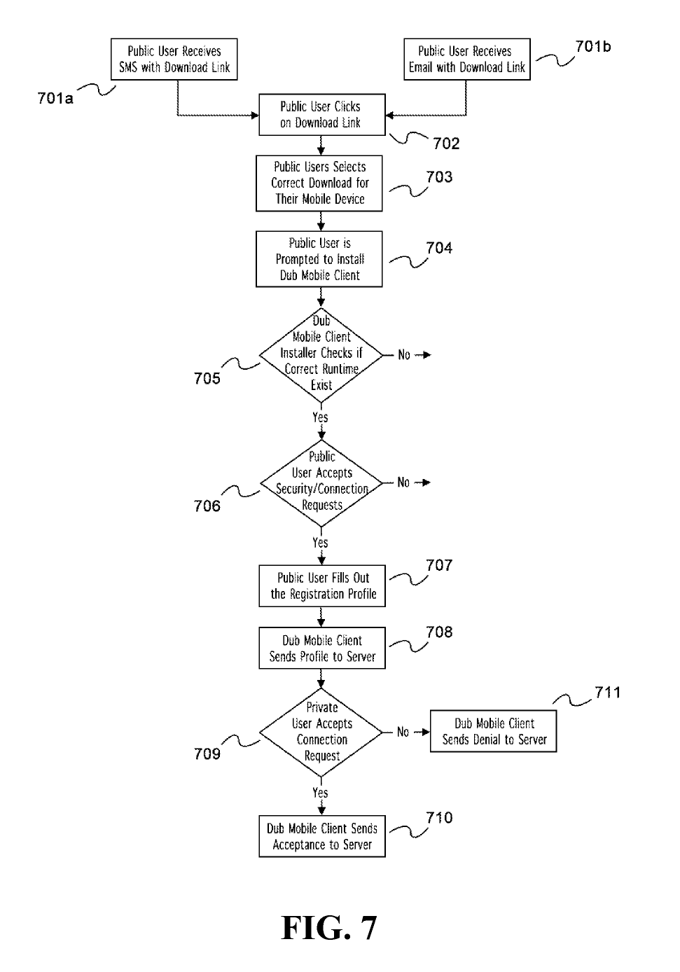

FIG. 7 exemplarily illustrates a flowchart of a process of providing a mobile client 202a to a public user. The public user receives 701a and 701b an email or an SMS with a download link from the information exchange server 206. The public user then clicks 702 on the download link. The public user then selects 703 correct download for the smartphone. The public user is then prompted 704 to install the mobile client 202a. A mobile client installer application then checks 705 if correct runtime of the mobile client 202a exists while downloading the mobile client 202a. If the mobile client 202a does not have the correct runtime, information on minimal requirements for installation and link to download the proper runtime is provided on the public user's smartphone. The mobile client installer application then installs the mobile client 202a on the public user's smartphone. The public user then accepts 706 security and connection requests from the information exchange server 206 through the mobile client 202a installed on the private user's smartphone. The public user then fills 707 required information fields in the public user's registration profile using the mobile client 202a. The mobile client 202a on the public user's smartphone then sends 708 the registration profile to the information exchange server 206. On sending the registration profile, the public user becomes a private user. The information exchange server 206 then sends connection request to the private user's smartphone for establishing connection between the private user and other private users. If the private user accepts 709 the connection request, then the mobile client 202a sends 710 the acceptance to the information exchange server 206. If the private user declines 709 the connection request, then the mobile client 202a sends 711 the denial to the information exchange server 206.

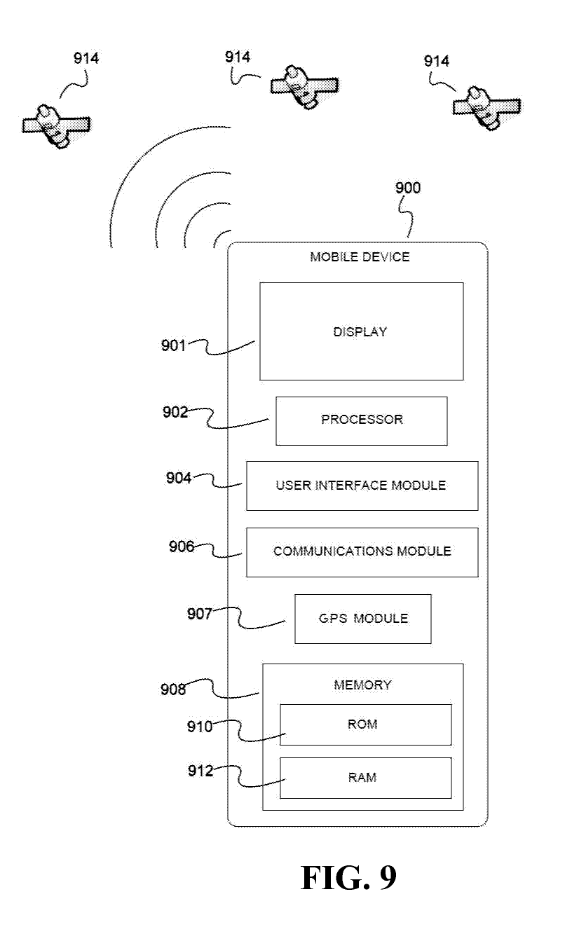

FIG. 9 is a block diagram illustrating the basic components of an example mobile device 900 which may be employed with systems and methods of this invention. As shown, the mobile device 900 includes a display 901, a processor 902, a user interface module 904, a communications module 906, and memory 908, including ROM 910 and RAM 912.

The processor 902 may include any hardware and/or software necessary for operating and/or controlling the user interface 904, the wireless communications module 906, and the memory 908. For example, the processor 902 may be individual digital logic components, a processor, a microprocessor, an application-specific integrated circuit (ASIC), and the like. The processor 902 may have its own memory such as random access memory (RAM), register memory, cache memory, and the like.

The processor 902 may be in communication with and/or in control of the user interface 904, the wireless communications module 906, and/or the memory 908. For example, the processor 902 may direct the user interface 904 to receive input from the user or present content on display 901, transmit or receive data via the wireless communications module 906, or retrieve preferences from a user profile stored in the memory 908.

The processor 902 may operate on computer-executable instructions. Computer-executable instructions may include computer-readable instructions, for example machine code, byte code, script language, runtime code, and the like. The computer-executable instructions for example, when executed by the processor 902, may cause the processing component to perform the methods described in FIGS. 1 and 4-7.

The user interface 904 may be, in any combination of hardware and/or software, any component, system and/or subsystem for receiving input from a user and/or outputting information to the user. The user interface 904 may include display 901, a number pad, or a keyboard. For example, the user interface 904 may include a telephone keypad, programmable softkeys, mechanical buttons, touch screens, and the like. One or more display screens 901 may provide visual output, for example the display of content pertinent to systems and methods of this invention. The user interface 904 may include a speaker for audio output and/or a microphone for audio input.

The wireless communications module 906 may be, in any combination of hardware and/or software, any component, system, and/or subsystem for providing wireless communications to or from the mobile device. The wireless communications module 906 may provide a wireless communications channel between wireless devices. The wireless communications module 906 may provide point-to-point wireless communications between mobile device 900 and a peer device. For example, the wireless communications module 906 may communicate in accordance various commercially available BLUETOOTH® protocols, and the like.

Wireless communications module 906 may provide radio frequency (RF) communications between mobile device 900 and other fixed and wireless devices, for example computing device 302, mobile device 303, smart phones 304, as well as other cell phones, laptops, PDAs, and other commercially available communications devices. Wireless communications module 906 may provide a wireless communications channel between mobile device 900 and a wireless communications network. Wireless communications module 906 may provide cellular communications or wireless data network communications, for example Wi-Fi (IEEE 802.11), WiMAX (IEEE 802.16), and the like.

Memory 908 may be any component, system, and/or subsystem suitable for storing data. For example, memory 908 may include storage media in the form of volatile and/or nonvolatile memory such as read only memory (ROM) 910 and random access memory (RAM) 912. A basic input/output system (BIOS), containing basic routines that help to transfer information between components within mobile device 900, such as during start-up, is typically stored in ROM 910. RAM 912 typically contains data and/or application modules that are immediately accessible to and/or presently being operated on by processor 902.

Mobile device 900 may also include other removable/non-removable, volatile/nonvolatile storage media that can be used as part of memory 908, for example hard disk drives, optical disc drives, flash memory cards, and the like. The storage media discussed above provide for storage of computer-readable instructions, data structures, program modules and other data for the mobile device 900, which may be executed on processor 902.

A GPS module 907 may be integrated as the location based service 380 in accordance with the present invention. Together with various satellites 914, the GPS module 907 is capable of determining the current location of the mobile device 900. Three GPS satellites 914, of the total of twenty-four GPS satellites 914 that circumnavigate the globe, are shown to transmit power radio signals at a predetermined frequency in the UHF band. The GPS signal contains three different pieces of information, i.e., a pseudo-random code, ephemeris data, and almanac data. The pseudo-random code identifies the transmitting satellite 914; the ephemeris data tells a GPS receiver where the GPS satellite 914 should be at any time throughout the day; and the almanac data, which is constantly transmitted by each satellite 914, contains important information about the status of the satellite, i.e., healthy or unhealthy, and current date and time.

A GPS receiver within the GPS module 907 uses an internal antenna to capture GPS signals sent by the three GPS satellites 914. The GPS module 907 calculates pseudo ranges from the satellites 914 to its own position within the mobile device 900. By receiving the GPS signals from the GPS satellites 914, the GPS module 907 is able to compare the time each received signal was transmitted by the satellites 914 with the time the signal was received. The GPS module 907 may use this comparison information to calculate degrees longitude and latitude and to triangulate the position of the mobile device 900. Although not shown in FIG. 9, the mobile device 900 also contains an antenna for transmitting and receiving wireless communications. The location of the mobile device 900 could also be determined through use of cell tower triangulation through receipt and transmission of wireless signals from one or more cell towers, transmitters, and/or wireless devices.

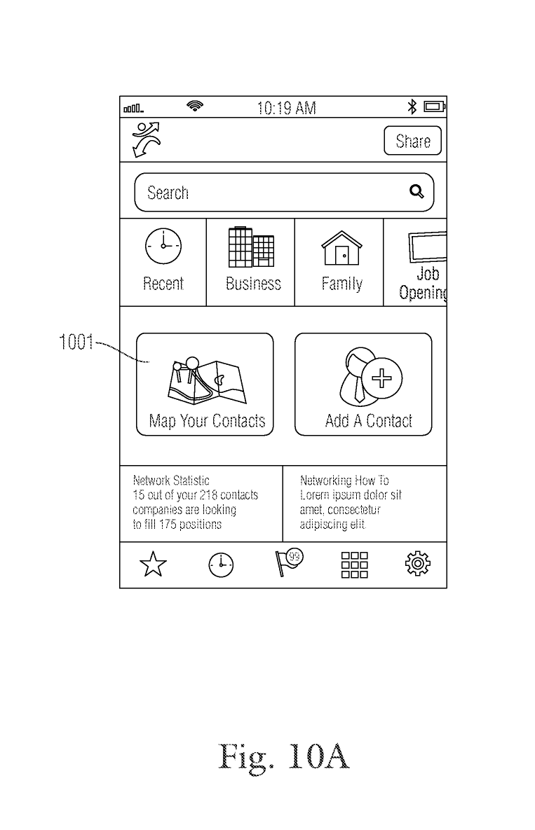

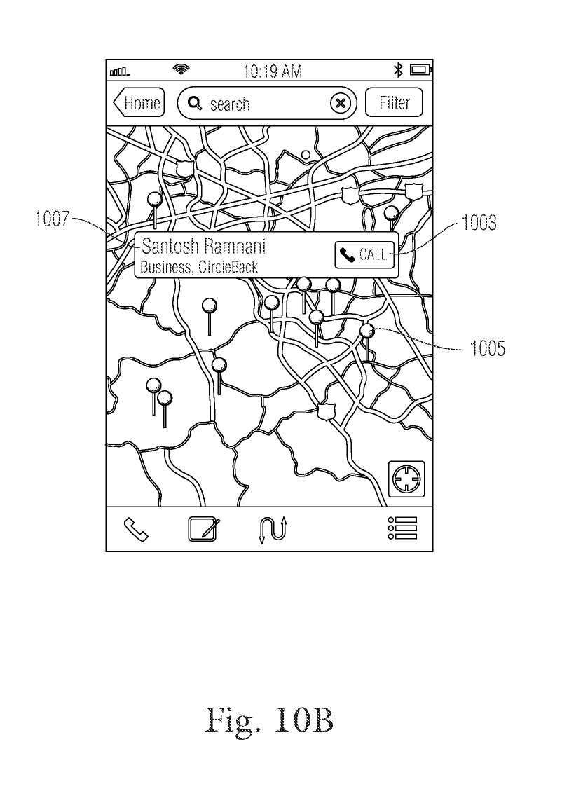

Using the GPS module 907 to determine the location of the mobile device 900, the present invention provides a system and method of mapping a user's contacts. As depicted in FIGS. 10A-10B, utilizing the present invention, the user may access a map application 1001 that displays his location as well as the location of all nearby contacts 1005, including personal and business contacts. The detailed map, as illustrated in FIG. 10B, places a pin or an identification icon 1005 to distinguish the user's location and other pins to distinguish the location of nearby contacts. The pins are color-coded to identify whether the contact is a client, friend, or family. The user may also edit and create different color pins to identify other contact groupings. The user may tap on the pin to reveal the name of the contact and the contact's title 1007. While still on the map display, the user may also call the contacts located near him by tapping on the pin and selecting the “call” icon 1003. The mapping could use the address location of the contact information. In the preferred embodiment, the GPS module 907 identifies the GPS location of the mobile devices of the user's contacts.

By way of example, a user is on a business trip to Seattle. Because the user is not native to the area, he is able to utilize the present invention to find contacts currently located nearby. The user enters the mapping functionality and notices thirteen contacts are within a ten mile radius of his hotel. By reviewing the color pins on the map display, the user can decide whether to connect with a business associate or a personal friend. In addition, the user may use the present invention to get advice on places to eat, places to visit, and activities in the area by reaching out to other contacts living in the area, in the example, Seattle.

An additional application and embodiment of the present invention provides a system and method for processing orders, requests, and transactions through the address book of a mobile device. As seen in FIG. 2, a business organization 207 may make use of the system of the present invention to both collect and share contact information with users but also to engage their contacts, users and customers. Specifically, the business organization, vendor, service provider, or company 207 may provide their business contact information. The business contact information is available through the network 205 and stored on the information exchange server and available to user 203 for inclusion in their address book 202f, 204a. Through use of the present invention both the business 207 and the user or customer 203 are updated of any changes either makes to their contact information.

In addition, the business 207 may provide products and services through the system including product and service ordering, updates and alerts, offers and promotions, and the storage of pertinent user data. The system of the present invention also provide businesses with the ability to provide such services including utilization of location based logic to provide real-time topical and relevant offers.

As an example of the capabilities and functionality of the present invention a user 203 obtains and or exchanges contact information with an airline business 207. The user 203 is provided contact information for the airline business 207 such as phone number, web address, reservation phone number, and other relevant contact information. In addition, the airline business 207 is able to provide public and private content to the user 203. The public content might be news, announcements, and general notifications. The private content could include loyalty or customer numbers, current or pending itineraries or orders, notifications and alerts, and account information. Finally, the airline business 207 can provide a commerce functionality which will enable users to process orders and payments through the address book contact for the airline business 207.

Continuing with the example, the user 203 has booked a round trip air travel from New York to Seattle with the airline business 207. The user 203, while in Seattle, determines he needs to extend his stay and needs to modify his return flight and itinerary. The user 203 finds the airline business 207 contact information from within the address book 204a. The user 203 is able to utilize the contact information to process a new order or change an order or the user 203 is able to utilize the commerce component and functionality to modify or process an order. Still further, because the system is able to determine that the mobile device 204 is located in the Seattle area and knows the customer's contact information, itinerary, order, customer number and billing information, the airline business 207 can send real time information and offers to the user 203. Thus, the airline business 207 may make logical location and time based determinations to enhance the ordering process such as prompting or offering the user to modify the return flight based on time and location. The user 203 can process the order or accept the offer and the airline business 207 can process the transaction utilizing all of the information available through the system.

In addition, upon acceptance of an order change such as a flight modification the status of the user within the system can be updated and would allow the airline business 207 to provide additional offers such as lodging, meals, and entertainment. Additionally, the system enables other business organizations 207 which the user 203 has in their address book 204a to provide real time offers based on location. As readily apparent from the description the system is particularly useful for hotels, restaurants, and entertainment businesses which can notify the user 203 of offers, availability, pricing, ratings, and other relevant content and information based on location, time, and status changes.

Another aspect and benefit of the present invention relates to transaction processing and security. The present system allows the user 203 to have each individual business 207 process payment by providing payment information to all selected business organizations 207 the user 203 has in their address book 204a or to only provide their payment information within a secure account within the user's account on the network 205. The network 205 can incorporate and utilize their own payment processing system to process orders between users 203 and a business 207. The payment processing module will provide notification to the user 203 and the business 207 of successful payment and enable fund transfer to the participating business organization 207 thereby limiting the need for users to provide billing information directly to each business 207.

The system would enable business organizations 207 to provide one or more administrators who can set up and maintain their business contact information within the system. In the preferred embodiment, the business contact information would have at least three components which include the contact information component, the private and public content component, and the commerce component. Business organizations 207 could personalize the business contact information with logos, color schemes, marketing call outs and other logical user interface modifications. Further, the system would enable the business organization 207 to link its profile within the system to the business organization's 207 external social profiles, such as Facebook, Twitter, Google+, and LinkedIn. The system compares a number of factors, such as profile names and contact information, in determining whether the external social profiles belong to the business organization 207. The system may automatically make this determination or an administrator may manually link the business organization's 207 profile with its external social profiles. Before automatically linking the external social profiles with the business organization's 207 profile, the system prompts the administrator for permission to link. If no administrator is assigned, the system can be set to automatically link the external social profiles with the business organization's 207 profile. Once linked, the information exchange server 206, or a secondary server of the system, regularly pulls the business organization's 207 social data from its external social profiles and adds recent updates, posts, and information found on the external social profiles to the business organization's 207 profile on the mobile client. By way of example, a restaurant uses the mobile client to input contact information onto its business profile. The system finds a Facebook and Twitter account using the same handle or name as the restaurant and the same contact information. The system then links the restaurant's profile on the system with the external Facebook and Twitter profiles. On a regular basis, the system pulls the restaurant's social data from Facebook and Twitter and stores recent activity. More specifically, for purposes of this example, the system pulls the last five tweets the restaurant's Twitter profile and the last five posts on the restaurant's Facebook profile. The system stores this information on the server and adds the five tweets and posts onto the restaurant's profile.

In addition, administrators for the business organizations 207 would input contact information for the business 207. The contact information may be static or dynamic based upon location of the user's mobile device. By way of example, the contact information may changed based on location such as a different phone number based on locality. As previously described, the businesses 207 would also be able to provide public and private content to the user 203. The public content might be news, announcements, and general notifications. The private content could include loyalty or customer numbers, current or pending itineraries or orders, notifications and alerts, and account information. Alerts and notifications could be contained within the contact profile 201a within the address book 204a or be sent as an email, SMS text message, or phone call to the wireless device. Finally, the airline business 207 will be able to provide a commerce component through the system which will enable users to process orders and payments through the address book contact for the airline business 207. Payment can be processed by the business 207 as described above in reference to FIG. 3 or by a payment process component or module associated with the system.

Through the present invention, users may have one or more businesses 207 or service provider contacts in their address books 204a. Each individual provider is attempting to build and garner adoption of their own applications. However, users want an easy to use tool or system which provides access to all of the businesses and providers they utilize. The present invention enables businesses 207 to create their own micro-mobile application using the tools of the present invention enabling customers to add their contact in the user's 207 address book and enhance the ease with which user's can contact, interact, and order products and services.

Businesses 207 and service providers are able to use the system and reduce their investment in building multi-platform mobile applications. The present invention is multi-platform enabling businesses to reach customers across the various mobile platforms utilizing the users' address book. The user is able to have real time updated contact information and meaningful offers and order processing via their address book. Further, because each account may contain their customer number the user can reduce the clutter and information carried in their wallet or purse. Further, everything can be easily accessed and launched from the user's address book and the actions are also traceable via their address book.

In use, the business or company 207 will have one or more administrators set up a profile through a standard website and graphical user interface associated with the system. The administrator is presented enhanced or additional screens for inputting contact information, public and private content, and for promotional and commerce components. The system will allow interaction at a sophisticated level such that business can both send information to and receive information on users in a real time setting such as location, time, and status. Further, the business may receive demographic information on users viewing the business organization's profile. Such demographic information may include, but not limited to, the geographic location of the user, the user's age, the user's gender, and the user's occupation. The business 207 can provide static or dynamic information and utilize an API or equivalent to develop applications through an SDK or equivalent associated with the system to provide enhanced interaction and communication with users.

The present invention can also provide enhanced security features to users like remote phone lock, data wipe, contact rebuild, and location assistance. Further, the system could integrate various incentives such as loyalty points, multi-party discounts, consolidated payment and order processing.

The system would be particularly useful for Airlines and other travel related businesses, Restaurants, Car rental companies, theaters and cinemas, Grocery Stores, gyms and health clubs, retail stores, salons and barbers, medical and dental offices, and many other businesses. Further, the system will integrate with well known services and websites such as kudzu, open table, and other sites and features to seek reviews, price checks, availability and other relevant information on businesses and their products and services.

Businesses can increase loyalty and interaction with users and customers at critical moments such as during their purchase decision thereby strategically being relevant when needed. The system is ideally suited to work with business on an advertising model, revenue share model, transaction share model, monthly subscription model. In addition, as the system may provide payment processing directly to users with transaction reconciliation with the businesses the system can generate additional fees in transaction fees.

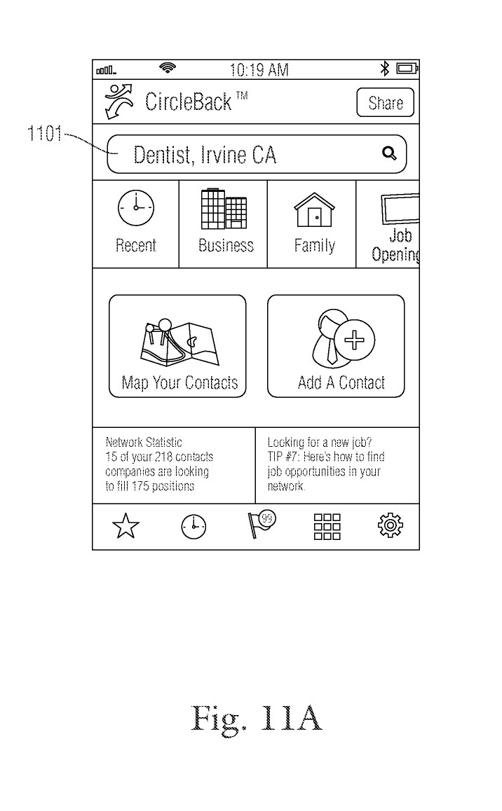

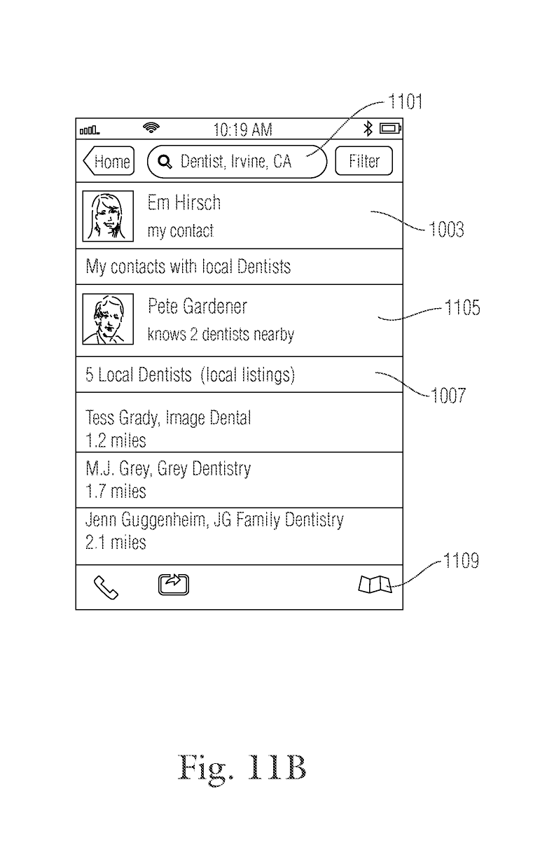

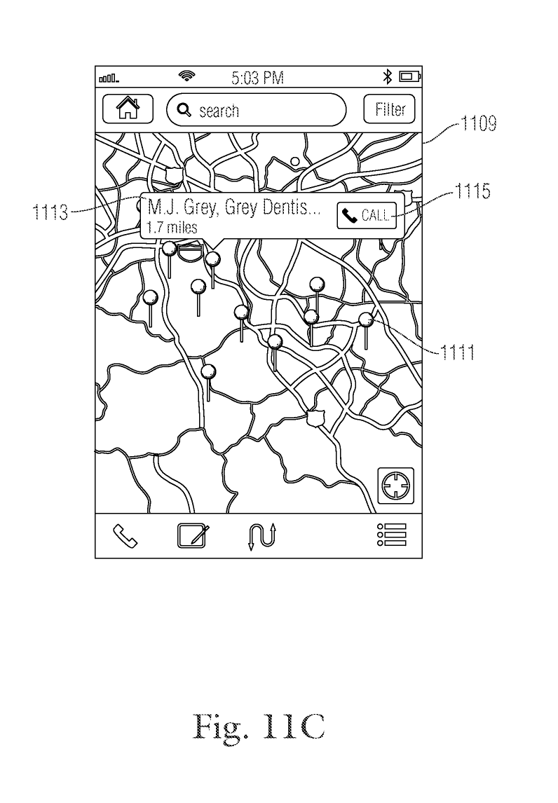

An additional embodiment of the present invention provides a system and method for a social search function to find local service providers that are connected to contacts in the user's address book and within the user's regional location. As discussed above and seen in FIG. 2, a business organization 207 may provide their business contact information. This information is available through the network 205 and stored on the information exchange server. Through the use of the present invention and as depicted in FIGS. 11A-11C, a user may search for a type of service or a specific service provider by entering keywords in the search box 1101. As illustrated in FIG. 11B, the present invention displays three sets of information: (1) local service providers the user is already connected with are presented in window 1103; (2) contacts of the user connected to local service providers are presented in window 1105; and (3) all relevant service providers within the local region are presented in window 1107. The user may select any one of the results to see contact and other relevant information. Such information might include reviews, discounts, specials, and any additional connections between the service provider and user.

As illustrated in FIG. 11C, the user may also utilize the map functionality 1109 of the present invention to view the location of the service providers 1111, retail stores, or shopping centers. Similar to the map contacts functionality discussed above, the system places a pin or an identification icon 1111 to identify the location of nearby service providers, retail stores, or shopping centers. The user may tap on the pin to reveal a window 1113 providing the name of the service provider, retail store, or shopping center, and the distance the service provider, retail store, or shopping center is located from the user 1113. While still on the map display, the user may also call the service providers located near him by tapping on the pin and selecting the “call” icon 1115.

By way of example, a user wants to search for dentists located in Irvine, Calif. The user is able to utilize the present invention to search for both local service providers around him and local service providers he and/or his contacts are connected to. This allows the user to select trusted local service providers and receive recommendations and references from his contacts. Continuing with the example, the user's search displays one dentist the user is already connected with, two dentists his contact is connected with, and five local dentists. The user retrieves his contact's information from his address book, and sends his friend a message inquiring about the two dentists his friend is connected with. The user's contact provides feedback on the dentists to enhance the user's decision. Through the present invention, service providers are encouraged to connect with and engage their customers to form positive relationships that entice contacts to provide recommendations to generate new clients. In addition, the system provides a platform for driving leads for service providers. The leads can come through advertising to receive premium placement in the local dentist window 1107 or to receive top listing in which every category window the service provider falls. Still further, the platform could be used by service providers to offer specials, discounts, and services to their contacts based on referrals stemming from the service or can be used to determine which contacts have the largest contact networks so they can entice them with special deals for the potential return value of future customers.

In addition, the present invention provides a system and method of discovering and posting job opportunities in the user's network. A business organization or user may post job opportunities, which are available through the network and stored on the information exchange server. The user may also use the present invention to find contacts that have job openings at their companies. Utilizing the present invention, a user may discover these job opportunities and may also determine who in his network may be connected to the job opportunity.

As an example, a user is interested in applying for a new job in web development. The user uses the present invention to search for available positions in web development. From the list of posted job opportunities, the user may determine which of his contacts posted a job opportunity, are employees of a business organization with a job opportunity, or know of individuals connected to the business organization. Further, since many companies provide a referral bonus for employees who refer a new employee, the system can be used by a company's employees to post openings or to allow their network to find applicants which the employee can filter and submit. Continuing with our example, the user decides to apply for an open position at a web development company. By using the present invention, the user discovers his old college classmate is an employee at the company and he sends an electronic communication to the classmate inquiring about the job opportunity. The classmate is able to use the present invention to review his own contacts and connect the user to other individuals who may be of help in learning more about or submitting information for the job opportunity.

In addition, the present invention provides a system and method to increase a user's chance of being found by potential new employers, prospects, or customers. The present invention allows a user to add a list of specialties onto his profile. For example, the user may list a range of specialties such as product development, SEO, SEM, marketing consulting, accounting, and legal services. These keywords and descriptions can be used by hiring managers and recruiters to search their employee's network of contacts to find users with such specialties for recruiting purposes. By using keywords to describe the user's specialty, the user increases his chances of being discovered by potential new employers, prospects, and customers.

Another novel aspect of the present invention is the ability for the system to merge contacts from various sources in a way which minimizes or eliminates the potential for data loss. Specifically, as described in reference to FIGS. 3A and 3B, a user can easily merge and connect their internal address book 357 to external contact information systems which include a user's contacts such as social networks 372, contact management systems 370, other vendors 382, or internet sites. Examples of these external contact information systems include websites and services such as LinkedIn, Facebook, Twitter, Yahoo, Gmail, hotmail, outlook, other mobile phones, and any other site or service which stores contacts, lists of contacts, and information about those contacts for users. The system of the present invention is able to access a user's various accounts with each external contact service the user selects to retrieve contact information from each account. Access to each service is obtained by having the user provide access credentials or through various access methods such as single sign-on, openid, or the OAuth (Open Authorization) standard which uses tokens instead of usernames and passwords after a user grants access to a third party. Each token grants access to the system on behalf of the user to a specific site for specific resources.

Once the user provides access to one or more contact service accounts, the system can automatically pull in contact information from the services with no data loss during merging. Specifically, the system and technology finds names, phone numbers, and email matches, and mashes all contact information for one name together into one record aggregating all unique contact data into one view and any new contacts are added to the user's stored address book on the system and any contacts already in your stored address book are updated. Then the stored address book from the user's account can be synced to the address book on their mobile device. The system is designed with a “plug-in” architecture so that new external systems and services can easily be added to the contact merge process once a user grants access to the account or contact information on the third party service or application. Another benefit is the drag and drop feature which enables users to log into their account where they can interact with their merged address book and using their mouse can drag one contact on top of another. This will perform an automatic contact merge with no loss. Therefore, in the event that a user discovers that during the merge process an account was created for John Smith and a second account was created for John A. Smith but they are the same contact, the user can merge those contacts through the drag and drop feature for orderly organization.

As contact information in users' external contact services is updated such as when new contacts are added or contact information is updated on one of the other services, the system will automatically retrieve the new information and add it to the merged all in one contact record within a user's stored address book on the system. Therefore, all of the user's contact information can be synced to one source and synced to their mobile device to have accurate and real time contact information available on their mobile device.

Further, as previously described, the system enables mutual users of the system to connect and enjoy real time updates automatically. When system connects users who have also merged contact information from multiple sources, the system can lock certain fields which it identifies as fields provided by a connected user so that other connected users can identify the contact information which is mostly likely the current and best information. Further, this lock feature prevents users from changing or editing good or current contact information.

Another relevant aspect of the present invention is the merge process of the various contact information data obtained from various sources. The system enables an administrator of the system to establish a hierarchy of which data sources have priority over other data sources during the merge process. Although the process enables all information to be stored and viewable there is still a desire to establish which information is deemed most current and relevant. Further, the system can also be configured to enable the user to establish the hierarchy of which contact information data sources have priority.

The all merged contact information module also has additional benefits including a search component, search toolbar, and a tag or list export feature. Specifically, the system provides users the ability to conduct a search of their merged address book from their mobile device. The search function is also being configured to work with external applications such as Outlook through use of a toolbar which will also enable users to initiate emails straight from the search results. This will enable users to search their merged address book even though their email address book (i.e. Outlook) may not have all of their contacts or updated contact information. Additionally, the user will be able to tag each contact with one or more tags to create searchable groups or lists. The tags or lists will enable users to narrow a large address book into groups as well as incorporate useful administrative tools. These administrative tools might include printing address labels, ordering holiday cards, sending an email newsletter, or the like all based on a tag or list.

One element related to a merged contact address book that user's would like the ability to separate is the ability to separate personal contacts from business contacts. Although tags or lists is one way to separate the contacts users ideally might want to provide separate contact information to the different groups such that personal contacts might receive business and personal contact information while business contacts will only receive business contact information. The system enables users the control to select which information is received or available to other members of the system. The user can establish which fields are available to connected members based on the tags or list or, in the preferred embodiment; a user can have multiple contact cards or records. Therefore, a user can create a personal contact record to share with personal contacts and a business contact record to share with business contacts. As business contacts become friends the user can update the access a selected contact has so they might be granted access to both the business and personal contact record.

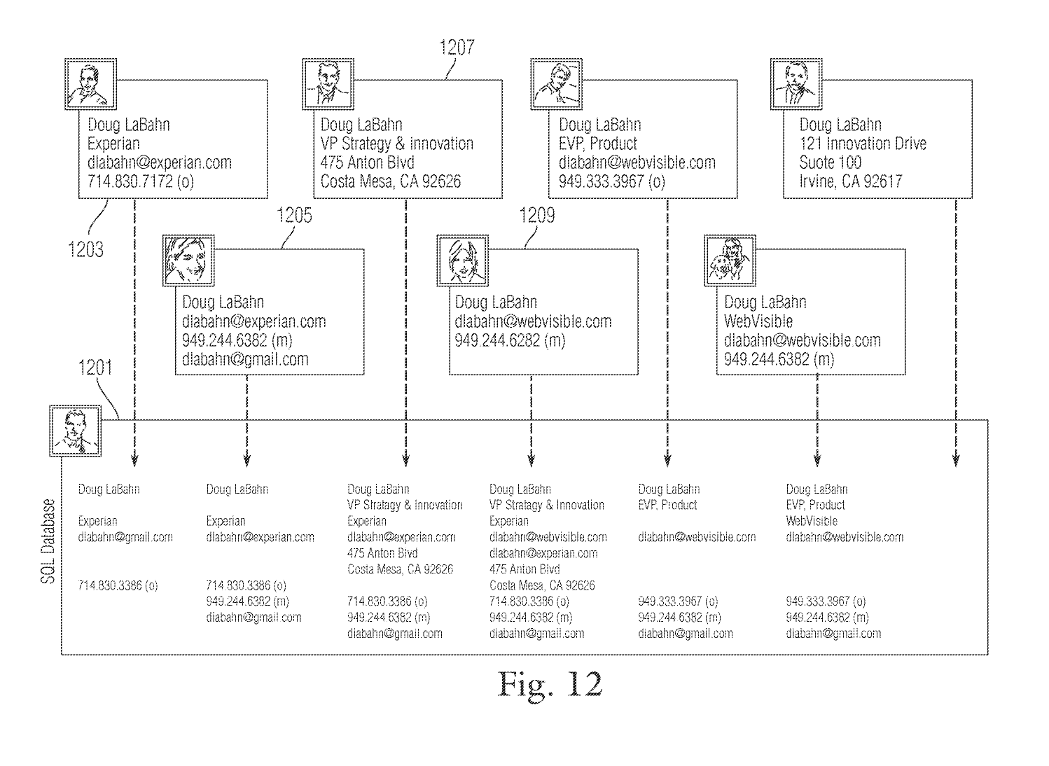

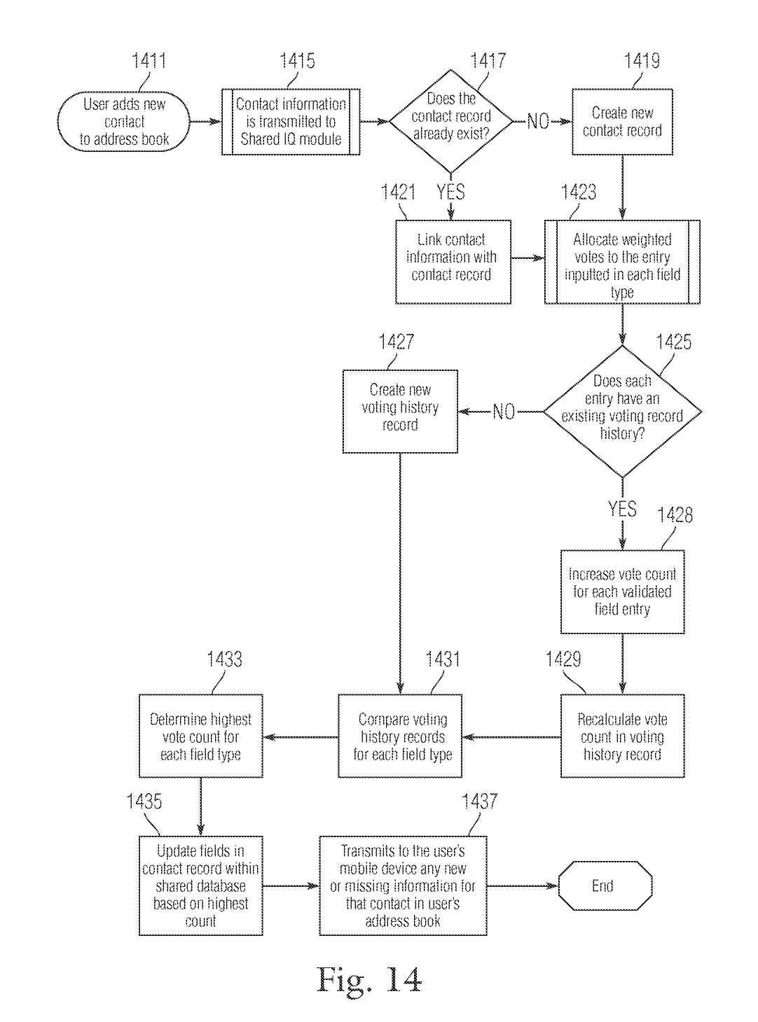

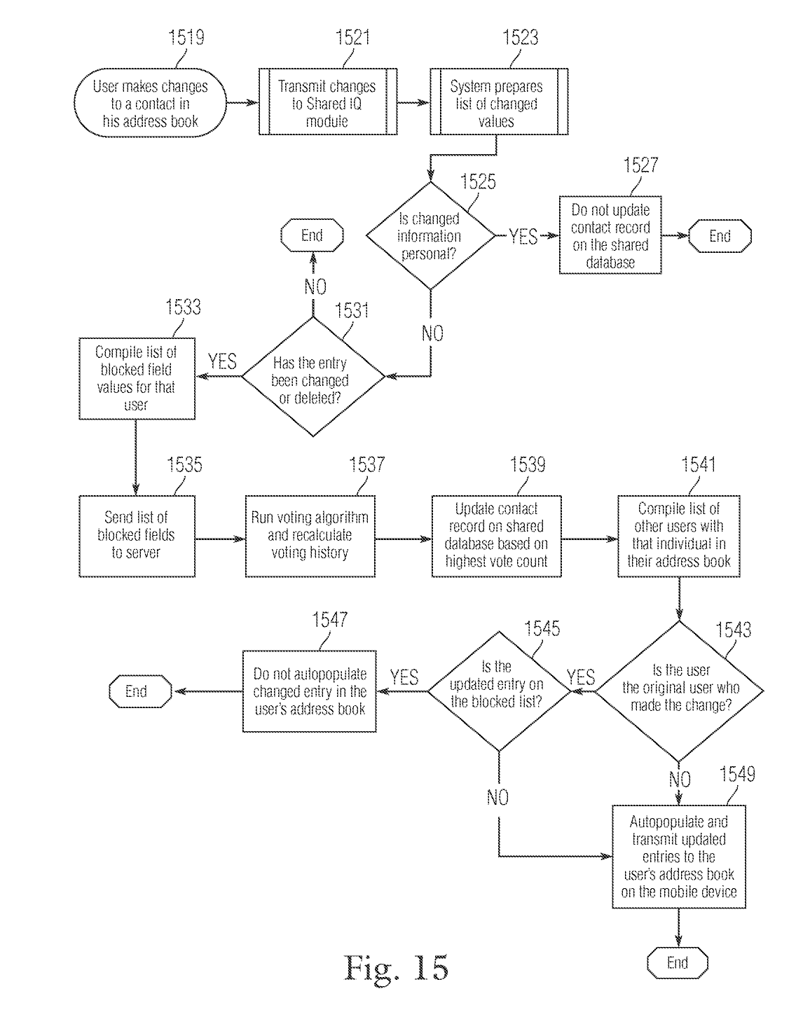

In the preferred embodiment, the present invention further comprises a crowdsourcing intelligence module (hereinafter referred to as “Shared IQ module”) that provides the software, analysis, and algorithms for automatically populating and updating an individual's contact record profile based on contributed information and changes made to that individual's profile by a large group or community of users. As depicted in FIG. 12, when a user inputs an individual's contact information 1203 into his address book, the information is automatically stored into the database 1201. The database may be local or in the cloud. To provide the most complete and up-to-date profile about that individual, the Shared IQ module uses a voting system and algorithm, which is further described in conjunction with FIGS. 14 and 15, to analyze each record of an individual's contact information found in contact information records 1205, 1207, 1209 from the address book of other users. The system first extracts the individual's contact information found in the individual records 1203, 1205, 1207, 1209 of each address book from other users and aggregates all this information together into one contact record that is stored in the database and available through the information exchange server. When an individual's contact information is added to a user's address book, the system determines if a contact record for that individual already exists and, if so, links the individual's contact information with an existing contact record found on the server. If a contact record does not exist, the system will create a new record for that individual. The system appropriately matches the individual with an existing contact record by searching all existing contact records in the database for matching field entries, such as name, phone numbers, email addresses, and other identifying information. In addition to searching what has been determined to be the most current information for an existing contact record, the system also searches the entire voting history record of existing contact records such that older contact information, i.e. an old business email address, may assist in linking or matching the individual with an existing contact record. Based on the existing contact record, the system is able to associate a partial contact record entered or submitted by a user to a complete or more complete contact record and then auto-populates the missing fields of the individual's contact information on the user's address book. In the preferred embodiment, the system will only auto-populate missing fields relating to the individual's business contact information.

In creating and maintaining the contact record in the database, the system utilizes a voting algorithm to determine which contact information is most accurate and up-to-date. As discussed above, a contact record of each individual is stored in a database and available through the information exchange server. Utilizing the mobile client, a user enters an individual's contact information into the various fields in his address book. The field types in the user's address book may include, but are not limited to, a field for the individual's name, home phone number, work phone number, mobile phone number, home email, work email, home address, work address, and etc. Additional field types may also be added by the user. Once the user has completed entering all known contact information, the entries and its respective field type are communicated or transmitted to the server. The server then allocates a specified number of votes to the entries entered in each field type by the user and stores the votes in the voting history record. The data or input values for each field type are considered votes which validate known data or diminish the validity of known data at the field type level. In the preferred embodiment, the system only assigns votes or weighted information to business contact information. The weight or value of each vote allocated is dependent on a number of factors, such as the field type, the source or closeness of the information to the contact (i.e. family member, co-worker, or external websites), the frequency of communication, the timestamp of when the entry was added, the decay value, whether a user manually added the new contact, and whether a user edited a contact already in their address book.

The weighting of each vote is established at the system level and can vary with each type of vote. In the exemplary embodiment, there are five types of votes which include: (1) a crowd vote; (2) an external vote; (3) an auto populated vote; (4) and owner vote; and (5) an admin or administrator vote. A crowd vote is one in which a user, or member of the crowd, enters information about a contact. An external vote is one stemming from an upload of or access to an address book such as a gmail, facebook, a CSV file or comma delimited file. An auto populated vote is one in which a user enters limited information about a contact but then receives and confirms additional information provided by the system. An owner vote is one in which a user claims ownership of a contact records and provides or confirms contact information. An admin or administrator vote is one in which a system administrator enters specific information which might be required to make needed admin level adjustments. The system then records each entry or response for each field as a vote and also records the type of vote and the date and/or time the vote was made. Further, the system allows a weighting factor to be applied for each type of vote such that an owner vote or an admin votes might count much more than an external vote or an auto populated vote. When new information or data for a specific field for a contact is provided, the system recalculates the value of each entry for that specific field by adding up the value of each vote factoring in its weighting factor due to the vote type and factoring in any decay factor or reduction due to the length of time since a vote was made.

In an exemplary embodiment, the weighting values each vote type might be provided might be 1.0 for a crowd vote, 0.5 for an external vote, 0.5 for an auto populated vote, 20 for an owner vote, and 1000 for an admin vote. By way of example, the system has received and stored two business phone numbers for a given contact. The first phone number was received and stored by the system six (6) months ago by a user who manually entered the information on their mobile device. The system stored the vote and that this type of vote was a crowd vote, and the date and time of the vote. The system calculates the total value for the business phone number field as 1 vote multiplied by the vote type weighting factor multiplied by the decay factor. Assuming a decay factor of 10% every 3 months the total vote value for phone number one after 6 months is 0.8 which is determined by the 1 vote*1.0 (the crowd vote type weighting factor)*0.8 (the decay factor associated with a 20% decay deduction). Now assuming a second business phone number is received by the system and stored by the system through an external address book uploaded through a Gmail account. The system calculated the value of the second business phone entry as 0.5 which is determined by the 1 vote*0.5 (the external vote type weighting factor)*1.0 (no decay since the entry has just been received). Since the first business phone entry value of 0.8 is higher than the 0.5 value for the second business phone entry the system sets the first business phone number as the primary number in the shared contact information database. Assuming three (3) months later a user claims ownership of the contact record and confirms that the second business phone entry is the preferred entry. The system would then recalculate all business phone entries. The system would determine the first business phone value as 0.7 which is determined by 1 vote*1.0 (the crowd vote type weighting factor)*0.7 (the decay factor associated with a 30% decay or reduction associated with a 9 decay time). The system would determine the second business phone value as 20.45 stemming from the total value of the 20.0 owner vote value added to the 0.45 external vote value. The 20.0 owner vote value is determined by taking the 1 vote*20.0 (the owner vote type weighting factor)*1.0 (no decay). The system calculated the external value of the second business phone entry as 0.5 which is determined by the 1 vote*0.5 (the external vote type weighting factor)*0.9 (a 10% decay associated with a three month period). Since the system has determined that the second business entry has a higher today value (20.45>0.7) the system would set the second business phone entry as the primary phone entry within the shared contact record.

The system may also incorporate a closeness factor by determining the closeness between the source of the information in relation to the contact. The system determines how close this relationship is by analyzing and determining the individuals connected to both the source and the contact, determining whether there is a familial relationship between the source and the contact, determining whether the source and the contact work or have worked at the same company before, and the like. In determining the closeness between the source and the contact, the system also accounts for the frequency of communication between the source and the contact. The frequency of communication may account for the number of phone calls made and received, emails sent and received, texts sent and received, and the like. Based on the closeness in relation between the source of the information and the contact, the system may assign a special vote type or a special vote weight (or weighting factor). The system also incorporates a decay factor to each vote because contact information may only be accurate for a short period of time. As more users add contacts the contact information for those contacts continues to be updated and validated. When a contact's information for a given field is validated by multiple similar entries, the votes add to each other for that given field to provide a strong likelihood that that specific field is likely to be accurate. However, if a contact has switched information, such as his business email, it would take a considerable time to override the total votes even if the votes for validating that field were quite old. Thus, by employing a decay factor, the value of one vote diminishes over time such that a new piece of information for a given field is appropriately recognized. Thus, for purposes of this example, the vote value of a business email address might decay by 10% every month. Therefore, within 10 months, the information validating vote would have no further impact. Additionally, contact information added by an individual to his own profile is allocated more weight value than contact information added by other users. This is because the owner is likely to provide the most accurate contact information relating to his own profile. However, if the individual has not updated his profile in a long time, the vote decay would impact that individuals' profile in the contact record on the shared database since other users might provide different information which through the voting algorithms overtakes the older information. Further, contact information submitted by a user who has imported contacts from an external source (e.g. Gmail, Outlook, and Yahoo) may have a different weighted value (i.e. 50% value or half a vote) than information personally edited by a user.

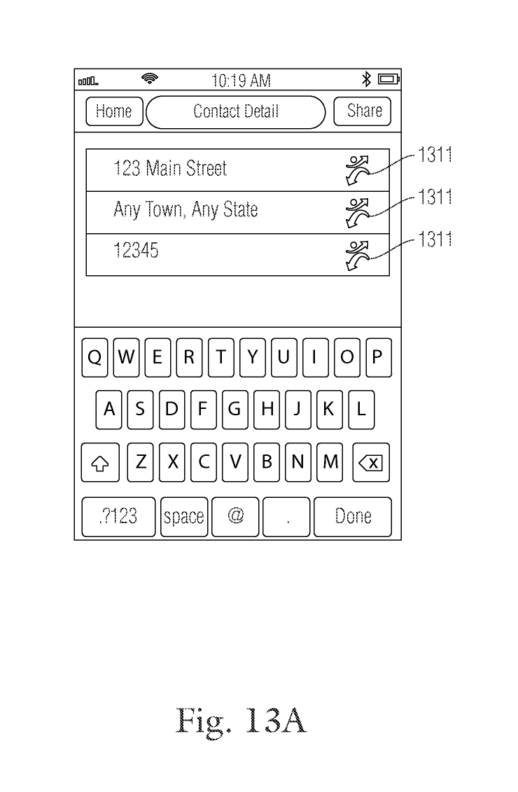

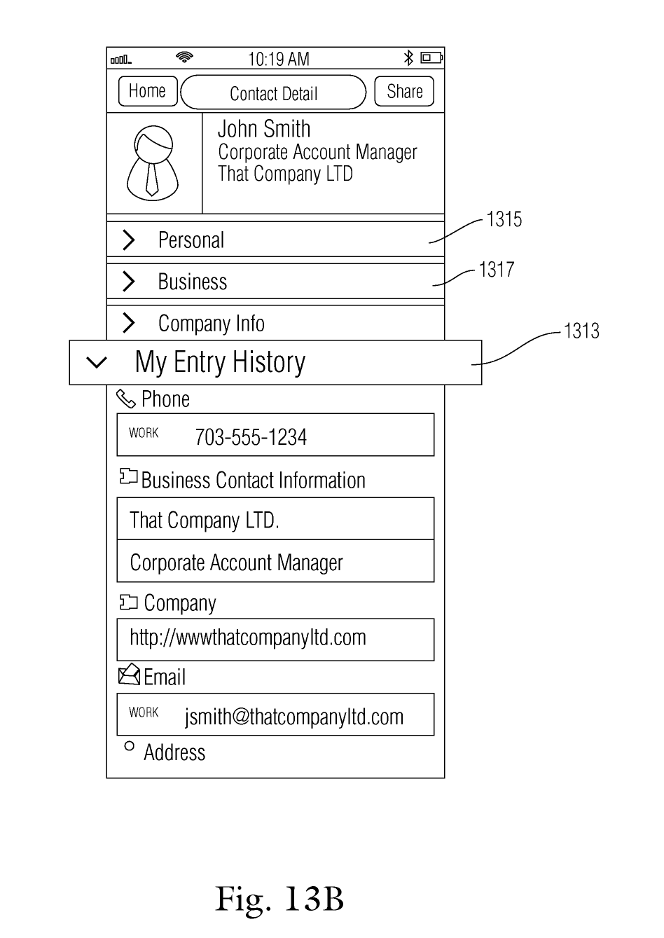

Once the votes and weighting and decay factor are allocated, the system sums the weight values of all the votes taken from all users having a given individual's contact information in their address book and stores the vote count in that field's voting history record. The voting history record contains the history of all votes at the granularity of every field type value. For every vote submitted, the system keeps track of which information has been entered, which field type the information has been entered in, how many votes or users has entered the same information in the same field type, the time it was submitted, the decay factor, what was changed, who submitted the change, and etc. Based on which information received the highest number of votes or vote number, the system then assigns that information as the preferred or optimal information. The system then uses the optimal information to auto-populate the contact information for that individual and transmits that information to each user who has that individual in their address book. The transmission may be pushed automatically or transmitted when a user activates the mobile application, web application, or that individual's contact record. To confirm the automatic populated information in the record is correct, the individual or owner of the information can claim their profile and confirm or edit their profile information. Further, any user can also look at the data he entered, even if the data he entered is not the optimal information as determined by the system for a specific contact within the My Entry History folder as depicted in FIG. 13B.

By way of example, a first user creates a new contact in his address book. The first user enters the newly added individual's business email address and business phone number into the business email address field and business phone number field in the user's address book, respectively. The user's address book may be the user's main mobile phone address book or the address book within a software or mobile application resident on the mobile device on phone. The user entered information is pushed or transmitted to the server. For purposes of this example, the server allocates one vote for the first business email address field and one vote for the first business phone field. A second user adds the same individual into her address book. The second user enters the same information as the first user into the appropriate fields on their mobile phone and the information is pushed to the server. For purposes of this example, the server allocates one vote for the first business email address field and one vote for the first business phone field providing a total of two votes for both the business email address and the business phone. A third user adds the same individual into her address book on her mobile device. However, the third user does not enter the same business email address and business phone number of the individual into his address book. The differing information is pushed or transmitted to the server where the server allocates one vote for the second business email address and one vote for the second business phone field. In creating and maintaining the contact record, the system adds all the users' votes to determine the information with the highest vote count. The first and second user entered the same business email address and business phone number. Thus, the first business email address and the first business phone number entered by the first and second user each has a total vote count of two. The second business email address and the second business phone number entered by the third user each have a vote count of one. Because the information entered by the first and second user have a higher vote count than the information added by the third user, the system updates the contact record on the shared contact database to reflect the information added by the first and second user. However, the shared contact database stores or retains the differing contact information and its total votes since additional users may soon add or validate that information to add to its vote count.

FIG. 14 provides a flow chart of the steps for creating the contact record in the database using the voting algorithm. In step 1411, the user adds a new individual's contact information to his address book. The information is then transmitted to the Shared IQ module in step 1415. In step 1417, the system determines whether a contact record already exists for the individual by searching through all contact records and voting history records in the shared contact database to find matching email addresses, phone numbers, or other identifying information. If no contact record exists for the individual, the system will create a new contact record in the shared contact database for that individual in step 1419. If a contact record does exist, the system links the user with that individual's contact record with the shared contact record in step 1421.

In step 1423, the system allocates weighted votes to the entries inputted in each field type. As explained above, the weighted votes are allocated on a field type level and the weight of each vote is dependent on a variety of factors such as the source of the information, the field type, the closeness factor, and the time the vote was entered (i.e. to factor in fresh content and account for vote decay). In step 1425, the system determines if the entry inputted in the field type has already been entered by other users. That is, whether the information entered in the field type already has an existing voting history record. If the information has an existing voting history record, the system increases the vote count in the voting history record in step 1428. If the entry does not have an existing voting history record, the system creates one. As explained above, the voting history record keeps track of which information has been entered, which field type the information has been entered in, how many votes or users has entered the same information in the same field type, and etc. For example, the system allocates one vote for information entered in the business email address field and the business phone number. A first user enters businessemail@email.com in the business email field for an individual and the business phone number in the business phone number field. For purposes of this example, no other email address has been entered by other users. The system creates a voting history for businessemail@email.com entered in the business email field and a separate voting history for business phone number entered in the business phone number field. A second user enters differntbusinessemail@email.com in the business email field and the same business phone number for the same individual. Because the same business phone number has already been entered by the first user, the system increases the voting history of the business phone number by one vote or a weighted scale of one vote. The weighting may make the total vote worth less than or more than 1 vote.

In contrast, if the field entry does not have an existing entry the system in step 1427 creates a new voting history record for differentbusinessemail@email.com. In step 1431, the system compares the voting history records for each field type. The system in step 1433 then calculates the highest vote count for the entries added in each field type and accounts for the weighted value of each vote in this calculation. Finally, in step 1435, the system updates or establishes that contact record in the shared database to the contact information with the highest vote counts. For example, the system analyzes the business email field and determines that businessemail@email.com has a voting history record of 2 and differentbusinessemail@email.com has a voting history for 1. Because businessemail@email.com has a higher vote count than differentbusinessemail@email.com for the business email field type, the system updates the individual's contact record with businessemail@email.com.

Ultimately, in step 1437, the information for that contact record within the shared database record is then transmitted to the user's mobile device or web application and all missing or new information is updated on the user's address book on their mobile device or web application for that contact record. The address book may be the main address book of the mobile device or an address book within an application resident on the mobile device or web application.

In order to protect an individual's personal information, the system also determines whether certain contact information, such as an email, is personal or work based on the field type (i.e. personal home phone number, personal email address, etc.) and the domain. For example, in analyzing emails, the system may use domains to ascertain whether an email is personal or work by using a growing exclusion list of all ISP emails (e.g. gmail.com, yahoo.com, aol.com) to make this determination. In the preferred embodiment, only business contact information is stored in the contact record on the shared or crowd sourced database and assigned a weighted vote value by the system. However, the system could easily handle both business and personal contact information sharing. In the preferred embodiment, the system stores and uses personal contact information, such as personal emails and phone numbers, to find, compare and link existing contact records in the shared database with contact profiles in the user's address book. However, in the preferred embodiment, the system does not transmit the personal information in a shared contact record and does not auto-populate the personal information on a user's address book on their mobile device. In an alternative embodiment, the system may be programmed such that the system will use the voting algorithms to determine expected personal contact information and transmit or auto-populate personal information in a user's address book only if that individual has allowed the user to view personal information. The personal information may also be stored in the contact record, but may be restricted by the system from auto-populating unless permission has been granted by the individual.

Further, the Shared IQ module, code or application provides a method and system of transmitting up-to-date information of individuals in a user's address book enabling real time updated address book information on the user's mobile device. When a user makes changes to an individual's contact information in the user's address book, these changes are pushed or transmitted to the system servers (see FIGS. 2 and 3). The system analyzes the changed information and recalculates the voting history record of each field type. If any changes have been made to the contact information, the system pushes this up-to-date information to the mobile client of any users having that individual in their address book. In the preferred embodiment, the system only pushes business contact information to a user's address book. As depicted in FIG. 13A, an icon 1311 is displayed next to any information that had been automatically updated by the system. The icon 1311 provides a quick symbol to identify system validated contact information. The user may also view any information he has entered by viewing the “My Entry History” 1313 as seen in FIG. 13B.

FIG. 4 depicts a detailed flow chart of the real time updating process of a user's address book. In step 1519, the user makes changes to an individual's contact information in his address book by manually deleting information, adding information, or changing information. In step 1521, these changes are transmitted to the Shared IQ module or application resident on the system servers (see FIGS. 2 and 3). The system in step 1523 then prepares a list of changed values. In the preferred embodiment, the system only updates or establishes the business information in the shared contact record. Thus, in step 1525 the system determines if the information is personal information or business information. This determination is primarily an analysis of the field type or for emails the ISP or domain. If the information is personal the system, in step 1527, does not update the shared contact record and the process ends. However, if the information is not personal it is assumed to be business information and used to assess the shared contact information.

The system in step 1531 then reviews the changed field types and determines whether each changed entry is an addition, deletion, or update. If the changed field is a deletion or change, the system compiles these changed field types into a list of blocked field values for that specific user in step 1533. When a user manually changes or deletes a field in the individual's contact list, this casts a vote to the Shared IQ module. It is unlikely that one vote would change the calculated highest vote count for that entry unless it is a fairly new or very old record. Thus, the blocked field list allows the entry that the user had manually entered to stay in their contact list, even if the entry does not receive the highest vote count. In step 1535, the system sends the list of blocked field values to the server. If, in step 1531 it is determined that the changed entry is an addition, the system does not compile a list of blocked field values.

In step 1537, the system runs the voting algorithm analysis and recalculates the voting history values or record of each changed field type as previously described. The voting history values and record of each changed field type is based on the type of changes made, the field type changed, the source context of the change (i.e. the owner of the profile, connected users, or external social networking sites such as Facebook, LinkedIn, and Twitter), the decay factor for that field, and other factors. In addition, positive points or votes with positive weight are applied if new information was added and negative points or votes with negative weight are applied if information was removed or changed. In the case of updates, either positive or negative points, or votes with positive or negative weights, are applied. As described in FIG. 14, the system also incorporates the decay value of prior votes in its recalculation of the voting history record. Once the system has recalculated the votes for each changed entry, the system updates the contact record found on the shared or crowd sourced database based on entries receiving the highest vote counts in step 1539. In step 1541, the system then compiles a list of other users with that individual's contact record in their address book. Before pushing or transmitting the updates to each of the users' address book in the compiled user list, the system determines which user originally submitted the change contact information in step 1519. If so, in step 1545, the system determines if the updated entries being pushed by system appears on the list of blocked field values. If the information does appear on the list, the system does not push that particular entry to that user.

With regards to the remaining users on the compiled list of users with that individual in their address book, the system in step 1549 auto-populates any missing or updated information by transmitting the updated information to those users' address book. The transmission may by an automatic push, a pull or request made when the user opens the application, address book, or individual record, or may be a periodic sync process. As described in FIGS. 13A and 13B, an icon 1311 is displayed next to any information that had been automatically updated by the system and the user may view any information he has entered by selecting the “My Entry History” 1313. An additional step may be added in which the system prompts the individual to confirm any changes being made to his contact profile before pushing this information to other users.

By way of example, a user meets a new business associate at a networking conference. The user only enters the new business associate's name and email address into his address book. Based on this limited information, the system searches its database for an existing contact record with the same name and email address and updates the voting history record for the business associate's email address. The system then pushes only the individual's business information to the user's address book and automatically populates any missing fields. Such business information includes, but not limited to, the business associate's company name, company address, company telephone number, and company email. The user will see an icon 1311 (seen in FIG. 13A) next to each of the fields that have been automatically populated by the system. The system can also employ a request and approve step which would only send information to the user after the contact record owner approved of the sync.

Continuing with the example above, several months after the user has met the business associate, the business associate switches jobs. Because the user and the business associate do not communicate on a frequent basis, the user is unaware of the business associate's change of employment. Multiple co-workers connected to the business associate updates the business associate's profile in his address book to reflect the new job title and new email address. This information is received by the system, and the system recalculates the voting score of the new job title and email address. This updated information is then automatically pushed to the business associate's connections, including the user, where it updates the business associate's job title and email address. An icon is placed next to the job title field to indicate that the field was automatically populated by the server. The user may review the “My Entry History” tab to view the email address he had inputted during his initial meeting with the business associate.

As discussed above, in the preferred embodiment, the system neither stores personal information on the contact record nor automatically pushes or auto-populates personal information to other users. In an alternative embodiment, the system inspects and analyzes both business and personal contact information and stores the personal information on the contact record. The system may also automatically populate and update personal information to other users who have permission by the owner. The system may also employ a request and approval step in which the record owner must approve the dissemination of personal information updates to selected contacts.

Another element of the Shared IQ module is the system's ability to merge contact records that relate to the same individual. Because some individual's are known by other aliases or nicknames, such as Jennifer and Jen or William and Bill, the system will combine contact records to the extent the contact information are the same. The system may make its assessment based on matching a set of mandatory fields and supplemental fields. For example, the mandatory fields may require that the last name of the contact records match. The supplemental fields may require that there are at least three matching values in the field types, such as phone number, email, and address. The total number of mandatory and supplemental fields that must match can be modified and the set rules of the mandatory and supplemental fields may be modified. If the owner of the information is a registered user, the system provides the owner of the information an opportunity to review the contact records and grant permission to merge the records before combining the records. If the owner is not a registered user, the system will merge the contact records based on which contact record has the greatest number of votes. By way of example, the first user enters an individual, who is not a registered user, into his contact list as Jennifer. A second user enters that same individual into his contact list as Jen. A third user enters that same individual into his contact list as Jen. Both contact records include the same business phone number, business email address, and business work address. The system recognizes that both records have overlapping contact information, and merges the two records together. Because more votes have been cast on the “Jen” contact record than the “Jennifer” contact record, the system would merge the “Jennifer” contact record into the “Jen” contact record.

Further, the Shared IQ module provides for generating a database of company records. The database will already contain pre-populated company records of the top big companies. For example, the database may already contain pre-populated company records of the top 4,000 largest companies. For companies not pre-populated by the system, the system creates new company records as contacts are added into the system with email domains that do not yet exist in the system. The system then automatically populates and updates the company contact information using the same voting algorithm described in FIGS. 14 and 15. It should be noted that if a verified administrator of the company updates or edits the company profile, the weight of the administrator's vote is substantially higher than any other weighted vote such that the administrator's changes are the winning votes and the system will update the company record with these changes. The system also calculates the headquarters of an organization by analyzing how many contacts in the database are at the same location. Further, the system accounts for companies having multiple offices. The system may account for the multiple offices by using GPS in combination with locations or by creating separate contact records in the system and later merging or linking the multiple contact records. Similar to as described above, the system will prompt the administrator of the company profile for validation before merging the contact records. If no administrator has been assigned, the system will automatically merge the contact records based on which contact record has the highest number of votes.

In addition to contact information, the system uses external data to append other meta-information about the company, such as, but not limited to, industries, number of jobs, number of employees, size of the company, and etc. A “My Companies” feature allows users that have verified emails at the company to add, remove, and edit company meta-information. Similar to updating contact information, the system auto-populates and updates the company contact information based on the voting algorithm described in FIGS. 14 and 15.

Based on the company record, the system also auto-populates and updates the business information of contacts who are employees of that company. As described in FIG. 13C, any information updated or deleted by the user will be compiled in the list of blocked values except for Title and Organization field entries. That is, for that particular user, the system will not replace what the user has entered in his address book with the exception of the Title and Organization. The system auto-populates and updates the Title and Organization based on the voting history record. The user-entered Title and Organization are not displayed on the contact screen, but the user may review the Title and Organization, along with other user-entered data, in the “My Entry History” section 1313 (as seen in FIG. 13B). In addition, meta-information about the company stored in the company record is auto-populated in the work section of the contact record. The meta-information also includes a dynamically generated list of company employees by using the email domain of the company to find other contacts employed at that company. The user may view the other employees' business contact information and add them to his contact list. The system may also be set to sort the employee list with the most popular employee at the top.

In an additional embodiment of the present invention, the system provides for creating personalized contact lists, sharing the personalized contact lists with other users, and allowing a group of users to edit the personalized contact lists. Examples of personalized contact lists include, but are not limited to, a family contact list, a business contact list, a networking contact list, and an emergency list. As an example, the emergency contacts list may consist of the local fire department, family doctor, local hospital, local police, nutritionist, plumber, and babysitter. To create a personalized list, the user logs into their account such as through the web application or their mobile client, and searches for one or more contacts in their address book, and flags the contact(s) to be part of the personalized contact list. The user may also directly add the contact from the personalized contact list display.

In addition, the user may easily remove a contact from the personalized contact list by either unflagging the contact in their address book or by directly editing the personalized contact list. Contacts added to the personalized contact list are not restricted to registered mobile client users. The personalized contact list may also be shared with other users, and the creator of the personalized contact list may set restrictions and allowances on the shared personalized contact list. For example, the creator of the personalized contact list may restrict other users from editing the list or may allow other users to edit, update, or add contacts to the list. The creator of the personalized contact list may also share the list with users who do not have the mobile client. In addition, the contact information for each of the contacts is automatically updated by the crowd sourced, social or Shared IQ module described in FIGS. 14 and 15.

The system may also be set such that any changes or deletions made by other shared users to contacts on the shared personalized list are compiled in the list of blocked values as discussed in FIG. 15. That is, even if changes or deletions made by the shared user are not calculated as the winning vote count by the system, the system will not update the changed or deleted information. However, the system is not required to employ the blocked list functionality as discussed in combination with FIG. 15 and may be set to function such that the system automatically updates the contacts on the shared personalized list with values having the highest vote count.

By way of example, the creator is a member of a sorority at her university. Using either the web based application or her mobile client, the creator creates a personalized contact list of all members of her sorority. The creator shares the personalized list with all other members of her sorority and sets the restriction to allow any of the members to update, edit, or add contacts to the sorority contact list. A first member, who is also a user of the present invention accesses the shared list through their mobile client, and knowing that one of her sorority sisters is working abroad changes her sorority sister's contact information to include her international business address. The system recalculates the voting history record for the business address field type, but the international business address does not have the highest vote count. However, because the change was made by a member of the shared list, the system recognizes the international business address as a blocked value. Therefore, although the international business address does not have the highest vote count, the system does not automatically update or replace the address field within the address book of the first member.

The system also enables the users to organize, categorize, and label mobile phone contacts into contact groupings. The mobile client may filter contacts in the user's address book based on the contact groupings. Further, as discussed above, the detailed map illustrated in FIG. 10B depicts the location of the user's mobile device 900 and the locations of the user's contacts using color pins, which may identify the different contact groupings.

Further, the system enables users to link the user's address book on the mobile device (i.e. iPhone, Blackberry, Droid, etc.) with the address book on the mobile client such that the system automatically pushes updated contact information from the user's mobile client address book to the address book on the user's mobile device. Thus, users would not be restricted to the mobile client or the system's website for accessing their real-time updated address book. To link the two address books together, the user may create contact groupings, as discussed above, and set which contact groupings to link to his mobile device's address book. When a contact in the contact grouping is updated by the system, this information would be pushed to the address book on the mobile client and to the address book on the user's mobile device. By way of example, a user creates a business contact grouping and includes all of his business contacts in the group. The user sets up his mobile client to link the business contact group to the address book on his iPhone. A week later, one of his business associate updates her business email address on her profile using the mobile client. Because the user is connected to the business associate, the new business email address gets pushed to the user's mobile client address book and replaces the business associate's old business email address with the new one. In addition, the system finds the business associate's profile in the user's iPhone address book and updates the business associate's business email address in the user's iPhone address book. The user may also link individual profiles in his mobile client address book without creating a contact group.

Although this crowdsourced or contact information sharing has been described for determining best or weighted information for transmission to an address book on a user's mobile device, the system could easily apply to a web based or personal computer (“PC”) purpose. Specifically, a web based application would allow a shared or crowd sourced contact address book which is then synced to or connected to a user's address book on a web based address book account such as Gmail contacts or any web based email and contact address book feature or service. Still further, the system could be designed or adapted to be integrated with a desktop application or PC mail client such that a user's address book on the email client (i.e. Outlook, Windows Live mail, etc.) could be updated based on transmitted data from the shared contact information database.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms (a non-exhaustive list) of transitory and non-transitory computer-readable media include, for example, an electrical connection having one or more wires, a portable computer diskette, a floppy disk, a flexible disk, hard disk, magnetic tape, any other magnetic medium, a Compact Disc-Read Only Memory (CD-ROM), Digital Versatile Disc (DVD), an optical fiber, any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, .NET or JAVA. The software programs may be stored on or in one or more mediums as an object code. A computer program product comprising computer executable instructions embodied in a computer-readable medium comprises computer parsable codes for the implementation of the processes of various embodiments. Note that the computer-usable or computer-readable medium could even be paper or another suitable non-transitory medium upon which the program is printed, as the program can be electronically captured, via, for instance, optical scanning of the paper or other non-transitory medium, then compiled, interpreted, or otherwise processed in a suitable manner, if necessary, and then stored in a computer memory.

The mobile devices of the requestor 201 and the recipient 203 may support Java of Sun Microsystems Inc., more specifically Java 2 Micro Edition (J2ME™), Windows Mobile .Net Compact Framework of Microsoft Inc., Palm, Symbian™, Linux framework. Exemplarily, the mobile client 202a may be implemented on the J2ME platform. These environments provide functionalities in the libraries to create the user interface of the mobile client 202a and perform all the required functions of the method and system disclosed herein. Other advantages of these frameworks are portability across mobile devices that run on different operating systems. The mobile client 202a may be rendered independent of the operating system of the mobile device. Some of the mobile phones equipped with both wireless network and telephony data capabilities may use either of the two to communicate with the information exchange server 206. The transport protocol that is used between the mobile client 202a and the information exchange server 206 may be hypertext transfer protocol (HTTP), Secure Sockets Layer (SSL), or extensible markup language-remote procedure calls (XML-RPC).

Where databases are described such as the information database 206a, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, etc. that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

What is claimed is:

1. A system comprising:
one or more processors; and
a machine readable medium storing a set of instructions that, when executed by the one or more processors, cause the machine to perform operations comprising:
receiving a first set of contact information for a contact from a first user of a plurality of users, wherein the first set of contact information contains one or more entries within a plurality of contact information data fields;
receiving a second set of contact information for the contact from a second user of the plurality of users, wherein the second set of contact information contains one or more entries within the plurality of contact information data fields;
combining the first set of contact information and the second set of contact information to provide a combined set of contact information;
calculating a value for each entry for each data field of the one or more contact information data fields;
determining the highest valued entry for each data field of the one or more contact information data fields;
setting the highest valued data entry for each of the one or more contact information data fields as the primary entry for each field; and
sharing the highest valued entry for each data field with the first user and the second user.

2. The system of claim 1, wherein the calculation of the value of each entry for each data field is based on one or more of: the method the entry is received; the user type which submitted the entry; the date the entry was received; the frequency of communication between the user and the contact; and the association between the user and the contact.

3. The system of claim 2, wherein the user type is one of: a standard user; a contact record owner; or an administrator.

4. The system of claim 2, wherein the method the entry is received is one of: a bulk upload; a manual entry; or an auto-populated confirmation.

5. The system of claim 2, wherein the calculation of the value of each entry for each data field is includes a time decay factor reduction

6. The system of claim 1, wherein the highest valued entry for each data field for the contact are shared by transmitting the information to a mobile device of any of the first user or second user.

7. The system of claim 6, wherein the shared information updates the contact information of the contact within an address book on the mobile device.

8. The system of claim 6, wherein the shared information updates the contact information of the contact within an address book within a mobile application resident on the mobile device.

9. The system of claim 1, wherein the highest valued entry for each data field for the contact are shared by transmitting the information to a personal computer of any of the first user or second user.

10. The system of claim 9, wherein the shared information updates the contact information of the contact within an address book on the personal computer.

11. The system of claim 10, wherein the shared information updates the contact information of the contact within an address book within an email application resident on the personal computer.

12. The system of claim 1, wherein the shared information updates the contact information of the contact within an address book within a user's account resident on a web-based application.

13. The system of claim 1, further comprising the operations of:
determining if the entry for a first data field from the first user matches an entry for the first data field from the second user; and if they match,
adding the value associated with the entry from the first user to the value associated with the entry from the second user to increase the total combined value for the entry.

14. A system comprising:
one or more processors; and
a machine readable medium storing a set of instructions that, when executed by the one or more processors, cause the machine to perform operations comprising:
receiving contact information associated with a contact from a plurality of users, wherein the contact information contains one or more entries within a plurality of contact information data fields;
calculating a value for each entry for each data field associated with the contact;
determining the highest valued entry for each data field associated with the contact;
setting the highest valued entry for each data field associated with the contact as the primary entry for each field for that contact; and
sharing the highest valued entry for each data field associated with the contact with the plurality of users.

15. The system of claim 14, wherein the calculation of the value of each entry for each data field is based on one or more of: the method the entry is received; the user type which submitted the entry; the date the entry was received; the frequency of communication between the user and the contact; and the association between the user and the contact.

16. The system of claim 15, wherein the user type is one of: a standard user; a contact record owner; or an administrator.

17. The system of claim 14, wherein the method the entry is received is one of: a bulk upload; a manual entry; or an auto-populated confirmation.

18. The system of claim 14, wherein the calculation of the value of each entry for each data field is includes a time decay factor reduction.

19. The system of claim 14, wherein the highest valued entry for each data field for the contact are shared by transmitting the information to a mobile device of any of the plurality of users.

20. The system of claim 19, wherein the shared information updates the contact information of the contact within an address book on the mobile device.

21. The system of claim 19, wherein the shared information updates the contact information of the contact within an address book within a mobile application resident on the mobile device.

22. The system of claim 14, wherein the highest valued entry for each data field for the contact are shared by transmitting the information to a personal computer of any of the plurality of users.

23. The system of claim 22, wherein the shared information updates the contact information of the contact within an address book on the personal computer.

24. The system of claim 23, wherein the shared information updates the contact information of the contact within an address book within an email application resident on the personal computer.

25. The system of claim 14, wherein the shared information updates the contact information of the contact within an address book within a user's account resident on a web-based application.

26. A method for updating a shared contact information system associated with a plurality of users, the method comprising:
receiving a first set of contact information for a contact from a first user, wherein the first set of contact information contains one or more entries within a plurality of contact information data fields;
receiving a second set of contact information for the contact from a second user, wherein the second set of contact information contains one or more entries within the plurality of contact information data fields;
combining the first set of contact information and the second set of contact information to provide a combined set of contact information;
calculating a value for each entry for each data field of the one or more contact information data fields;
determining the highest valued entry for each data field of the one or more contact information data fields;
setting the highest valued data entry for each of the one or more contact information data fields as the primary entry for each field; and
sharing the highest valued entry for each data field with the first user and the second user.

27. A system comprising:
one or more processors; and
a machine readable medium storing a set of instructions that, when executed by the one or more processors, cause the machine to perform operations comprising:
receiving a first set of contact information for a contact from a first user of a plurality of users, wherein the first set of contact information contains one or more entries within a plurality of contact information data fields;
receiving a second set of contact information for the contact from a second user of the plurality of users, wherein the second set of contact information contains one or more entries within the plurality of contact information data fields;
combining the first set of contact information and the second set of contact information to provide a combined set of contact information;
calculating a value for each entry for each data field of the one or more contact information data fields; wherein the calculation of the value of each entry for each data field is based on one or more of: the method the entry is received; the user type which submitted the entry; and the frequency of communication between the user and the contact; and the association between the user and the contact; and wherein the calculation of the value of each entry for each data field is includes a time decay factor reduction;
determining the highest valued entry for each data field of the one or more contact information data fields;
setting the highest valued data entry for each of the one or more contact information data fields as the primary entry for each field; and
sharing the highest valued entry for each data field by transmitting the information to a mobile device of any of the first user or second user, wherein the shared information updates the contact information of the contact within an address book on the mobile device.
